(19) United States
(12) Patent Application Publication
(10) Pub. No.: US 2025/0173706 A1
(43) Pub. Date: May 29, 2025

(54) ORDERED, APPEND-ONLY DATA STORAGE

(71) Applicant: nChain Licensing AG, Zug (CH)

(72) Inventors: Andrew James MEE, London (GB); Ricky Charles RAND, London (GB); Paul CLARK, London (GB); Jack Owen DAVIES, London (GB); Wei ZHANG, London (GB); Alex WOODS, London (GB)

(21) Appl. No.: 18/715,631

(22) PCT Filed: Mar. 23, 2023
(86) PCT No.: PCT/EP2023/057562

§ 371 Date: May 31, 2024

(30) Foreign Application Priority Data
Mar. 25, 2022 (GB) 2204293.1
May 6, 2022 (GB) 2206682.3

(51) Int. Cl. G06Q 20/38; G06Q 20/40; H04L 9/00; H04L 9/32

(52) U.S. Cl. CPC G06Q 20/382; G06Q 20/401; H04L 9/3236; H04L 9/50

(57) ABSTRACT

A computer implemented method for adding a current transaction associated with a set of transactions in a blockchain system. The method comprising the steps of generating a first state data, wherein the first state data is based on a first transaction reference to a first transaction and/or a second transaction reference to a second transaction, generating the current transaction comprising the first state data, and submitting the current transaction to the blockchain.

### CROSS REFERENCE TO RELATED APPLICATIONS

This application is the U.S. National Stage of International Application No. PCT/EP2023/057562 filed on Mar. 23, 2023, which claims the benefit of United Kingdom Patent Application No. 2204293.1, filed on Mar. 25, 2022, and United Kingdom Patent Application No. 2206682.3, filed on May 6, 2022, the contents of which are incorporated herein by reference in their entireties.

### FIELD

The present disclosure relates to methods, systems, and data structures for implementing a platform of one or more services associated with a distributed ledger, i.e. a blockchain, for one or more clients. More particularly, the present disclosure relates, but is not limited to, the provision of data storage and verification of data storage associated with a blockchain.

### BACKGROUND

A blockchain refers to a form of distributed data structure, wherein a duplicate copy of the blockchain is maintained at each of a plurality of nodes in a distributed peer-to-peer (P2P) network (referred to below as a “blockchain network”) and widely publicised. The blockchain comprises a chain of blocks of data, wherein each block comprises one or more transactions. Each transaction, other than so-called “coinbase transactions”, points back to a preceding transaction in a sequence which may span one or more blocks up until one or more coinbase transactions. Coinbase transactions are discussed below. Transactions that are submitted to the blockchain network are included in new blocks. New blocks are created by a process often referred to as “mining”, which involves each of a plurality of the nodes competing to perform “proof-of-work”, i.e. solving a cryptographic puzzle based on a representation of a defined set of ordered and validated pending transactions waiting to be included in a new block of the blockchain. It should be noted that the blockchain may be pruned at a node, and the publication of blocks can be achieved through the publication of mere block headers.

The transactions in the blockchain are used to perform one or more of the following: to convey a digital asset (i.e. a number of digital tokens), to order a set of journal entries in a virtualised ledger or registry, to receive and process timestamp entries, and/or to time-order index pointers. A blockchain can also be exploited in order to layer additional functionality on top of the blockchain. Blockchain protocols may allow for storage of additional user data or indexes to data in a transaction. There is no pre-specified limit to the maximum data capacity that can be stored within a single transaction, and therefore increasingly more complex data can be incorporated. For instance this may be used to store an electronic document in the blockchain, or audio or video data.

Nodes of the blockchain network (which are often referred to as “miners”) perform a distributed transaction registration and verification process, which will be described in detail below. In summary, during this process a node validates transactions and inserts them into a block template for which they attempt to identify a valid proof-of-work solution. Once a valid solution is found, a new block is propagated to other nodes of the network, thus enabling each node to record the new block on the blockchain. In order to have a transaction recorded in the blockchain, a user (e.g. a blockchain client application) sends the transaction to one of the nodes of the network to be propagated. Nodes which receive the transaction may race to find a proof-of-work solution incorporating the validated transaction into a new block. Each node is configured to enforce the same node protocol, which will include one or more conditions for a transaction to be valid. Invalid transactions will not be propagated nor incorporated into blocks. Assuming the transaction is validated and thereby accepted onto the blockchain, then the transaction (including any user data) will thus remain registered and indexed at each of the nodes in the blockchain network as an immutable public record.

The node who successfully solved the proof-of-work puzzle to create the latest block is typically rewarded with a new transaction called the “coinbase transaction” which distributes an amount of the digital asset, i.e. a number of tokens. The detection and rejection of invalid transactions is enforced by the actions of competing nodes who act as agents of the network and are incentivised to report and block malfeasance. The widespread publication of information allows users to continuously audit the performance of nodes. The publication of the mere block headers allows participants to ensure the ongoing integrity of the blockchain.

In an “output-based” model (sometimes referred to as a UTXO-based model), the data structure of a given transaction comprises one or more inputs and one or more outputs. Any spendable output comprises an element specifying an amount of the digital asset that is derivable from the proceeding sequence of transactions. The spendable output is sometimes referred to as a UTXO (“unspent transaction output”). The output may further comprise a locking script specifying a condition for the future redemption of the output. A locking script is a predicate defining the conditions necessary to validate and transfer digital tokens or assets. Each input of a transaction (other than a coinbase transaction) comprises a pointer (i.e. a reference) to such an output in a preceding transaction, and may further comprise an unlocking script for unlocking the locking script of the pointed-to output. So consider a pair of transactions, call them a first and a second transaction (or “target” transaction). The first transaction comprises at least one output specifying an amount of the digital asset, and comprising a locking script defining one or more conditions of unlocking the output. The second, target transaction comprises at least one input, comprising a pointer to the output of the first transaction, and an unlocking script for unlocking the output of the first transaction.

In such a model, when the second, target transaction is sent to the blockchain network to be propagated and recorded in the blockchain, one of the criteria for validity applied at each node will be that the unlocking script meets all of the one or more conditions defined in the locking script of the first transaction. Another will be that the output of the first transaction has not already been redeemed by another, earlier valid transaction. Any node that finds the target transaction invalid according to any of these conditions will not propagate it (as a valid transaction, but possibly to register an invalid transaction) nor include it in a new block to be recorded in the blockchain.

An alternative type of transaction model is an account-based model. In this case each transaction does not define the amount to be transferred by referring back to the UTXO of a preceding transaction in a sequence of past transactions, but rather by reference to an absolute account balance. The current state of all accounts is stored by the nodes separate to the blockchain and is updated constantly.

One area of current research is the use of the blockchain for the implementation of “smart contracts”. These are computer programs designed to automate the execution of the terms of a machine-readable contract or agreement. Unlike a traditional contract which would be written in natural language, a smart contract is a machine-executable program, which comprises rules that can process inputs in order to produce results, which can then cause actions to be performed dependent upon those results. Another area of blockchain-related interest is the use of ‘tokens’ (or ‘coloured coins’) to represent and transfer real-world entities via the blockchain. A potentially sensitive or secret item can be represented by the token, which has no discernible meaning or value. The token thus serves as an identifier that allows the real-world item to be referenced from the blockchain.

The above-mentioned examples or scenarios, whilst making use of the advantages of the blockchain to provide a permanent, tamper-proof record of events; requires a client, client entity, computing devices, or a terminal associated with a client, to include or implement software and/or hardware, or a processor/module, such as a digital wallet for implementing functionality for managing digital assets, managing cryptographic keys for Elliptic Curve Digital Signature Algorithm (ECDSA) that are used, for example, by the BSV (Bitcoin Satoshi's Vision) Blockchain. In addition, there is also a requirement for the client device to be able to implement blockchain transaction construction and have access to BSV libraries.

Thus, not only do clients need to include processing to implement such functionality, but they also need to ensure that appropriate security measures are implemented for such processes before they can make use of a blockchain network to send, receive, and view data, and/or digital assets, which relate to a smart contract or a token representing a real world asset transaction.

Accordingly, there is a desire to implement secure, low-complexity, user-friendly, efficient, and robust techniques, that will allow any client, whether computationally sophisticated or not, to be able to instantaneously access and interact with useful applications associated with the blockchain, in a simple, fast, accurate, reliable, and secure manner, that is computationally and functionally less onerous. More particularly, there is a desire to make use of distributed ledger (blockchain) technology, and the advantages of increased security, transparency, and reliability of records, to provide a common platform or interface for a plurality of blockchain related services or applications, that enable any client computing device to ensure any data, event, or digital asset associated with the client, can be instantaneously and securely mined, or written into the blockchain easily, thereby providing a lasting, tamper-proof, and auditable record of it, which can be created, written, updated, read, or viewed as required. Further, a grouping of such data may be desired such that transactions may be traversed according to their group or otherwise associated with each other as they exist on the blockchain.

Such an improved solution has now been devised. The present disclosure addresses the above technical concerns by proposing one or more techniques, whereby data, or information associated with a client, may be simply, securely, and instantaneously written into, or obtained from the blockchain, by methods, devices, and systems which provide an application programming interface (API) for one or more services associated with a blockchain, without such clients needing to implement any processing or functionality for using the blockchain, while still being able to avail all advantages associated with the blockchain.

### SUMMARY OF THE INVENTION

In a first aspect, the present disclosure proposes methods, devices and systems for adding a current transaction associated with a set of transactions in a blockchain system, the method comprising the steps: generating a first state data, wherein the first state data is based on a first transaction reference to a first transaction and/or a second transaction reference to a second transaction, generating the current transaction comprising the first state data, and submitting the current transaction to the blockchain.

In a second aspect, the present disclosure proposes methods, devices, and systems for tracking livestock through use of the methods, devices, and systems of the first aspect.

Some specific components and embodiments of the disclosed method are now described by way of illustration with reference to the accompanying drawings, in which like reference numerals refer to like features.

### BRIEF DESCRIPTION OF THE FIGURES

FIG. 1 depicts an example system for implementing a blockchain.

FIG. 2 illustrates an example transaction protocol.

FIGS. 3A and 3B illustrate an example implementation of the client application and its user interface.

FIG. 4 illustrates an example of the node software that is run on each blockchain node of the network.

FIG. 5A is a schematic diagram depicting an overview of a chain of transaction storing log entries and the corresponding log entries.

FIG. 5B is a flow diagram depicting an example method for implementing an ordered append-only data storage system.

FIGS. 6 and 7 are schematic diagrams depicting the construction of Merkle trees for use within various embodiments described herein.

FIG. 8A-8D are schematic diagrams depicting example data structures according to various embodiments.

FIG. 8E is a flow diagram depicting an example method for implementing an ordered append-only data storage system.

FIG. 9 is a schematic diagram depicting two Merkle trees based on two different protocols.

FIGS. 10A, 10B, and 10C are schematic diagrams depicting example data structures according to various embodiments.

FIG. 11 is a schematic diagram, depicting an overview of a platform for a plurality of services associated with a blockchain, according to an aspect.

FIG. 12 is a schematic diagram, depicting the components of the platform of a plurality of services that are associated with a blockchain, according to an aspect.

FIG. 13 is a schematic diagram, illustrating a computing environment in which various aspects and embodiments of the present disclosure can be implemented.

FIG. 14 is a schematic diagram, illustrating the components of a platform of a plurality of services relating to an embodiment.

### DETAILED DESCRIPTION

In a first aspect, the present disclosure proposes a method for adding a current transaction associated with a set of transactions in a blockchain system, the method comprising the steps: generating a first state data, wherein the first state data is based on a first transaction reference to a first transaction and/or a second transaction reference to a second transaction, generating the current transaction comprising the first state data, and submitting the current transaction to the blockchain.

Preferably the set of transactions is a chain of commitments as described herein.

Optionally, the first transaction reference is based on an output of the first transaction.

Optionally, the first transaction reference is based on a second state data of the first transaction. Optionally, the first transaction reference is a reference to the previous transaction in the set of transactions. Thus, the first transaction reference can also be called a previous transaction reference. Advantageously, by basing the previous transaction reference on the output of the previous transaction of the set of transactions, a chain of back references is established, thereby enabling a party the ability to traverse backwards to find said previous transaction from the blockchain.

Optionally, the second transaction reference is based on a reference to an input of the second transaction. Optionally, the second transaction reference comprises an unspent transaction outpoint. Optionally, the second transaction reference is a reference to a next transaction in the set of transactions. Thus, the second transactions reference can also be called a next transaction reference. Optionally, the next transaction reference comprises an unspent transaction outpoint. Optionally, the unspent transaction outpoint is to be an input to the next transaction. Advantageously, by basing the next transaction reference on the input of the next transaction of the set of transactions, a chain of forward references is established, thereby enabling a party the ability to traverse forwards to find said next transaction from the blockchain.

Optionally, the first transaction reference and/or the second transaction reference is based on a reference to a sender account address and a nonce. Advantageously, the allows for the reference to be used on account-based blockchains. Thus enabling the chain of transactions to exist on an account-based blockchain either wholly or partially in a similarly secure manner as set out with respect to the UTXO-based blockchain.

When basing the state data on both forwards and backward references, the state data stored on the blockchain enables a party to traverse forwards or backwards through the set of transactions. The data on the blockchain therefore provides data to said party to determine which transactions in the blockchain are part of the set of transactions. Optionally, the state data item is one or more of the “State Digest (S)” embodiments as described herein.

Optionally, the first state data is of a known state size irrelevant of data the first state data is based on. Optionally, the current transaction is of a known transaction size. Optionally, the step of calculating a transaction fee to include the current transaction on the blockchain, wherein the transaction fee is calculated exactly. Optionally, the transaction fee can be calculated exactly given the known transaction size. Advantageously, having a known transaction size and transaction fee, the amount used to fund each transaction can be determined in advance and therefore the funding inputs can be generated in advance. With the funding inputs known in advance, they can be referenced (and therefore used as the second reference as discussed above).

Optionally, the first transaction reference and/or the second transaction reference are hidden from public view on the blockchain. Advantageously, only parties with the requisite knowledge are able to traverse the set of transactions.

Optionally, the current transaction is indistinguishable from any other transactions on the blockchain. Optionally, the current transaction is indistinguishable from other transactions that may also be part of a chain of commitments. Advantageously, this disallows any malicious third parties from see which transactions are part of the set of transactions and they are therefore unable to determine any sundry information about the set of transactions such as their total number, their frequency, or other information.

Optionally, the first state data is based on an output of a one-way function taking the first transaction reference and/or the second transaction reference as an input. Advantageously, this disallows a malicious third parties to reverse the data stored on-chain to arrive at the references—thereby further increasing the security.

Optionally, the first state date is PUSHDATA encoded. Advantageously, PUSHDATA encoding maintains the script in a valid format that is parseable by blockchain nodes. Thus, a node will not reject the transaction for comprising an invalid blockchain script.

Optionally, the first state data is based on a hash-based data structure based on the first transaction reference and/or the second transaction reference. Advantageously, a hash based data structure enables the data to be hidden (as a result of the one-way nature of the hash function) as well as being in a known format for other parties to use the data when appropriate.

Optionally, the first state data is a first Merkle tree root of a state Merkle tree and wherein the step of generating the first state data comprises generating the state Merkle tree. Optionally, the state Merkle tree comprises a first leaf node based on the first transaction reference and/or a second leaf node based on the second transaction reference. Advantageously, a Merkle tree root hides the contents of the Merkle tree but allows for reconstruction of the Merkle tree for verification of its contents. Therefore, this allows those with a Merkle tree proof to verify a Merkle tree was constructed using the same data.

Alternatively, the first state data is a final hash of a hash chain, wherein the hash chain is based on the first transaction reference, second transaction reference, received client data, a salt, metadata, and/or a version number.

Alternatively, the first state data is the output of a hash function where the input was the concatenation of the first transaction reference, second transaction reference, received client data, a salt, metadata, and/or a version number.

Optionally, the first leaf node is generated by passing the first transaction reference through a one-way function at least once. Optionally, the first leaf node is generated by passing the reference to the first transaction through a one-way function at least twice. Optionally, the second leaf node is generated by passing the second transaction reference through a one-way function at least once. Optionally, the second leaf node is generated by passing the second transaction reference through a one-way function at least twice. Advantageously, pre-hashing the leaf nodes of the Merkle tree provides an additional layer of irreversibility as to how the Merkle tree was constructed (and thus how the Merkle tree root was obtained).

Using a one-way function twice disallows a malicious third party to abuse any hash length attacks.

Optionally, the one-way function is a hashing function.

Optionally, the state Merkle tree comprises a first data item as a leaf node. Optionally, the first data item is based on any one or more of: data received from a client, a set of metadata about the set of transactions, a version number, and a salt. Advantageously, by basing the state Merkle tree on the data, in order to reconstruct the Merkle tree (and therefore Merkle tree root) a malicious third party must also know all of the client data, metadata, version number, and/or salt. This increases the security of the publicly available data.

Optionally, the first data item is a second Merkle tree root of a data Merkle tree and wherein the step of generating the first data item comprises generating the data Merkle tree. Optionally, the data Merkle tree comprises a number of data leaf nodes and the data leaf nodes are each based on one of the data received from the client, an item from the set of metadata about the set of transactions, the version number, and/or the salt. Advantageously, by basing the state Merkle tree on a further data Merkle tree (and preferably the Merkle tree root thereof), a further layer of indirection and verifiability is achieved. If malicious third party would need to not only know the contents of the first and second references as well as the client data, but also know how the Merkle tree is constructed including all of the other metadata, salt, etc. The data Merkle tree is also verifiable using a further Merkle tree proof to enable third parties to confirm that given data (for example their own client data) is represented in the data Merkle tree, which is then also represented in the transaction in the chain of transactions.

Optionally, at least one of the data leaf nodes are based on a concatenation with the version number. Versioning the Merkle trees enables the creator of the Merkle tree to update the layout or data stored on the Merkle tree.

Optionally, the first state data is stored on an output of the current transaction. Optionally, the output is an unspendable output. Optionally, the first state data is stored on the transaction after an OP_RETURN opcode and/or an OP_0 opcode. Advantageously, storing the data on the output of a transaction enables it to be stored on the blockchain. Use of OP_RETURN and/or OP_0 means that the transaction output is provably undependable. With a provably unspendable output, a blockchain node storing only spendable UTXOs need not store this UTXO thereby saving space across the wider blockchain network.

Optionally, the current transaction comprises a second data item. Optionally, the second data item is stored on an output of the current transaction. Optionally, the output is an unspendable output. Optionally, the second data item is stored on the transaction after an OP_RETURN opcode and/or an OP_0 opcode. Optionally, the second data item is PUSHDATA encoded. Optionally, the second data item is based on received client data. Optionally, the second data item is stored on the same output as the first state data. As discussed above, OP_RETURN and/or OP_0 make the output provably unspendable and PUSHDATA encoding ensures the blockchain script is still in a valid form for verifiers. Storing data based on the client data enables third parties to prove given data's existence (sometimes called a “proof of existence”) at a given time. Optionally, this second data item is one or more of the “Data Digest” embodiments as described herein.

Optionally, the second data item is based on the output of passing a data item based on the received client data through a one-way function at least once. Optionally, the second data item is based on the output of passing the data item based on the received client data through a one-way function at least twice. Advantageously, the use of a one-way function disallows a third party to reverse the function and discover what the client data was. Using one-way function more than once resistance to length-extension attacks is provided.

Optionally, the data item based on the received client data is salted. Salting any hashes or one-way function provides improved resistance to malicious parties trying reverse the one-way function (through use of rainbow tables for example).

Optionally, the data item based on the received client data is obtained by passing the received client data through a one-way function at least once. Optionally, the data item based on the received client data is obtained by passing the received client data through a one-way function at least twice. Advantageously, by passing the client data again through a one-way function, further layers protection against reversing the hash are provided thereby increasing the security of the public data stored on the blockchain.

Optionally, the one-way function is a hash function. Optionally, the second data item is generated according to the following function:

$${H}_{D} := {H}^{2} ( {H}^{2} ( D ) ‖ {H}^{2} ( SALT ) )$$

where H_{D} is the second data item, D is the client data, H² is a one-way function (preferably a hash function), and SALT is the salt.

Optionally, the client data is hidden from public view on the blockchain. Advantageously, hiding the data from public view on the blockchain stops malicious third parties from seeing it, thereby increasing the security of the system. Optionally, a representation of the client data is stored immutably on the blockchain. Optionally, the second data item provides a proof of existence of the received client data. Advantageously, an immutable proof of existence of data (optionally where the data is also hidden) allows owners of the data to selectively provide proofs of certain aspects of their data in a secure manner and without publicly displaying the data for all to see.

Optionally, the second data item is of a known size irrelevant of data the second data item is based on. Optionally, the current transaction is of a known transaction size. Optionally, the method further comprises the step of calculating a transaction fee to include the current transaction on the blockchain, wherein the transaction fee is calculated exactly given the known transaction size. As discussed above, there are a number of advantages to having a known (in advance) transaction size including precisely determining the fee required to include it in the blockchain as well as enabling pre-generation of any UTXOs to fund said transactions.

Optionally, the current transaction belongs to a second set of transactions and a third state data is generated based on a third transaction reference and/or a fourth transaction reference. Optionally, the third state data is stored on a further output of the current transaction. Optionally, the third transaction reference is of the same form as the first transaction reference. Optionally, the fourth transaction reference is of the same form as the second transaction reference. Advantageously, by belonging to a second set of transactions, the current transaction provides a way for two separate sets of transactions (or rather the logs and/or streams the sets of transactions relate to) to atomically, across both logs/streams, commit data to the blockchain.

Optionally, the first state data is further based on a third transaction reference and/or a fourth transaction reference.

Optionally, the method further comprises determining the second transaction reference before the second transaction is generated. Advantageously, the second (forward) reference can reference transactions on the blockchain before they exist through use of a transaction outpoint. Being able to create the link to the next transaction before the next one is known provides flexibility in that the data of the current transaction can be committed immediately without necessitating waiting for the next transaction to be generated.

Alternatively, the first transaction reference comprises data indicative that that the current transaction is a first transaction in the set of transactions and/or the second transaction reference comprises data indicative that the current transaction is a last transaction in the set of transactions. Preferably, the first state data is a Merkle tree root and of a Merkle tree wherein the Merkle tree is constructed comprising a leaf node or leaf nodes based on the third transaction reference and/or fourth transaction reference

Optionally, the data indicative that the current transaction is a first transaction in the set of transactions and/or the data indicative that the current transaction is a last transaction in the set of transactions is a byte string of zeros. Optionally, the first transaction reference is a null reference and/or the second transaction reference is a null reference. Optionally, the null reference comprises a byte string of zeros. Advantageously, using a null reference and/or known value of zeros allows the state digest to represent the known end cases. This is particularly of importance when traversing the set of transactions as a traverser will need to know when they are at the end or beginning of the set.

Optionally, the byte string of zeros is of the same length as the first or second transaction reference. Optionally, the byte string of zeros is 32 bytes long. Advantageously, using the same length as the first or second transaction, the data structure used in generating the state Merkle tree need not accommodate difference sizes.

Optionally, the method further comprises the steps of receiving a create stream message, the create stream message comprising an indication of conditions for a trigger, based on a trigger condition being met, conducting the following steps: obtaining data indicative of a state of the stream, and generating an append transaction comprising the data indicative the state of the stream. Preferably the append transaction is of the same form as the current transaction as described above.

Advantageously, by providing a trigger for generation (and subsequent submission) of a transaction that represents a current stream state, greater flexibility and selectability in how up to date the blockchain representation of the stream needs to be, is achieved. A client, upon creation of the event stream, can select aspects of the trigger depending on their requirements.

In some embodiments, the method further comprises the step of monitoring re-occurrence of the trigger condition.

When large amounts of data are stored in an off-chain database, a trigger condition may occur multiple times. By monitoring for when additional trigger conditions are met, the on-chain dataset is updated when needed.

In some embodiments, the method further comprises the step of generating and broadcasting an initial transaction comprising at least the indication of conditions for the trigger.

In some embodiments, the trigger condition is based on any one or more of the following: reception of a message indicating the stream is finalised, an elapsed time, a comparison of an elapsed time and a threshold time, and/or a comparison of a number of events received and a threshold number of events.

Advantageously, different trigger systems are provided for different client needs and can be selected by the client.

In some embodiments, the elapsed time is based on the time since a preceding trigger condition was met and/or the time since the create message was received. In some embodiments, the create message further comprises the threshold time.

Decoupling the submission of transactions to the blockchain from updates to the event stream preferably using the abovementioned feature provides a number of advantages including:
hiding the exact number of events that have occurred. For example, if it were known a stream was updated on-chain every 50 events, then a third party need only count every on-chain append transaction, multiply the count by 50 and have an approximate view of the total number of events. Depending on the smart contract associated, this may leak confidential information to third parties. Use of the present embodiment alleviates this by allowing triggering to be based on time, thereby not leaking any information about total number of events; and
preventing any loops occurring where, if your event stream is tracking its own on-chain submissions, then any event submitted to the event stream would trigger another event to be created and therefore another event transaction, and so on and so forth. Use of the present embodiment alleviates this by making the submission to the blockchain not based on every event received.

In some embodiments, the number of events received is based on the number of events received since a preceding trigger condition was met and/or a number of events received since the create message was received. In some embodiments, the create message comprises the threshold number of events. In some embodiments, the threshold number of events is 1. In some embodiments, the threshold number of events is greater than 1.

In some embodiments, the trigger condition is based only on the comparison of the elapsed time and the threshold time. In some embodiments, the trigger condition is based only on the comparison of the number of events received and the threshold number of events.

In the first aspect, there is also proposed a device comprising a processor and memory, the memory including executable instructions that, as a result of execution by the processor, causes the device to perform the computer-implemented method according to the first aspect above.

In the first aspect, there is also proposed a non-transitory computer readable storage medium comprising computer program code instructions, being executable by a computer, to conduct the method according to the first aspect above.

In the first aspect, there is also proposed a computer program comprising instructions which, when the program is executed by a computer, cause the computer to carry out the method according to the first aspect above.

In the first aspect, there is also proposed a system comprising a device according to the first aspect as described above, and a client device configured to submit data to the device such that a representation of the submitted data is included on a blockchain.

Optionally, the method according to the first aspect is for use with storage and tracking of livestock related data on the blockchain, comprising the step of: receiving an append event message comprising: an animal unique identifier, and a descriptor of an event associated with an animal associated with the animal unique identifier, and wherein the first state data is based on the animal unique identifier, and the descriptor of the event.

Preferably, the append event message relates to a vaccination performed on the animal associated with the animal unique identifier. More preferably, the animal unique identifier is determined using an RFID tag.

Optionally, the method further comprises the step of determining an event stream associated with the animal unique identifier.

Optionally, the previous blockchain transaction reference is a reference to a transaction associated with the event stream associated with the animal referenced in the animal unique identifier.

Optionally, the method further comprises the steps of receiving a verification request comprising an animal unique identifier and an event reference, obtaining a verification proof of an event referenced by the event reference, and transmitting the verification proof to a sender of the verification request. Preferably, the verification proof is a Merkle proof.

Optionally, there is provided a method of verifying an event associated with an animal, comprising the steps of: obtaining event data relating to the event; obtaining a proof of existence value from a transaction from a blockchain, wherein the transaction is associated with a set of transactions, and wherein the transaction was stored on the blockchain in accordance with a method according to any embodiment of the first aspect; obtaining a verification proof; and determining validity of the event data based on the verification proof and the proof of existence value.

In the first aspect, there is also proposed a system of livestock management, comprising: a user device; a livestock management database; a blockchain interface system; wherein the user device is configured to capture a unique identifier associated with an animal during an animal related event and transmit data relating to the event and the unique identifier to the livestock management database; wherein the livestock management database is configured to receive the unique identifier and the data relating to the event, and wherein the livestock management database is further configured to transmit the unique identifier and the data relating to the event to the blockchain interface system; wherein the blockchain interface system is configured to conduct the method of any one or more of the embodiments of the first aspect.

Optionally, the first state data is based on a third transaction reference, wherein the third transaction reference is based on a reference to a third transaction.

Preferably, the method further comprises the steps of obtaining a reference to a counting branch of transactions, generating a counting state data, wherein the counting state data is based on a number of branches in the set of transactions and a reference to a latest transaction in the counting branch of transactions, generating a counting state transaction comprising the counting state data, and submitting the current transaction to the blockchain.

Optionally, the first transaction reference and/or the second transaction reference is a reference to a transaction stored, or to be stored, on a further blockchain, wherein the further blockchain is different from the blockchain. Preferably, the first transaction reference and/or second transaction reference is a reference to an account-based blockchain. More preferably, the first transaction reference and/or second transaction reference comprises an account address and a nonce.

### Example System Overview

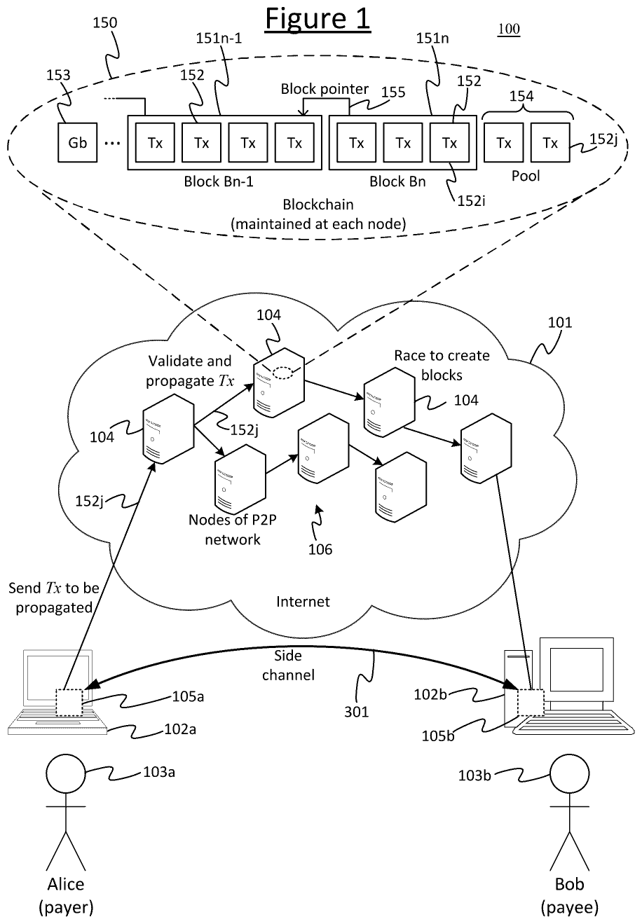

FIG. 1 shows an example system 100 for implementing a blockchain 150. The system 100 may comprise of a packet-switched network 101, typically a wide-area internetwork such as the Internet. The packet-switched network 101 comprises a plurality of blockchain nodes 104 that may be arranged to form a peer-to-peer (P2P) network 106 within the packet-switched network 101. Whilst not illustrated, the blockchain nodes 104 may be arranged as a near-complete graph. Each blockchain node 104 is therefore highly connected to other blockchain nodes 104.

Each blockchain node 104 comprises computer equipment of a peer, with different ones of the nodes 104 belonging to different peers. Each blockchain node 104 comprises processing apparatus comprising one or more processors, e.g. one or more central processing units (CPUs), accelerator processors, application specific processors and/or field programmable gate arrays (FPGAs), and other equipment such as Application Specific Integrated Circuits (ASICs). Each node also comprises memory, i.e. computer-readable storage in the form of a non-transitory computer-readable medium or media. The memory may comprise one or more memory units employing one or more memory media, e.g. a magnetic medium such as a hard disk; an electronic medium such as a solid-state drive (SSD), flash memory or EEPROM; and/or an optical medium such as an optical disk drive.

The blockchain 150 comprises a chain of blocks of data 151, wherein a respective copy of the blockchain 150 is maintained at each of a plurality of blockchain nodes 104 in the distributed or blockchain network 160. As mentioned above, maintaining a copy of the blockchain 150 does not necessarily mean storing the blockchain 150 in full. Instead, the blockchain 150 may be pruned of data so long as each blockchain node 150 stores the blockheader (discussed below) of each block 151. Each block 151 in the chain comprises one or more transactions 152, wherein a transaction in this context refers to a kind of data structure. The nature of the data structure will depend on the type of transaction protocol used as part of a transaction model or scheme. A given blockchain will use one particular transaction protocol throughout. In one common type of transaction protocol, the data structure of each transaction 152 comprises at least one input and at least one output. Each output specifies an amount representing a quantity of a digital asset as property, an example of which is a user 103 to whom the output is cryptographically locked (requiring a signature or other solution of that user in order to be unlocked and thereby redeemed or spent). Each input points back to the output of a preceding transaction 152, thereby linking the transactions.

Each block 151 also comprises a block pointer 155 pointing back to the previously created block 151 in the chain so as to define a sequential order to the blocks 151. Each transaction 152 (other than a coinbase transaction) comprises a pointer back to a previous transaction so as to define an order to sequences of transactions (N.B. sequences of transactions 152 are allowed to branch). The chain of blocks 151 goes all the way back to a genesis block (Gb) 153 which was the first block in the chain. One or more original transactions 152 early on in the chain 150 pointed to the genesis block 153 rather than a preceding transaction.

Each of the blockchain nodes 104 is configured to forward transactions 152 to other blockchain nodes 104, and thereby cause transactions 152 to be propagated throughout the network 106. Each blockchain node 104 is configured to create blocks 151 and to store a respective copy of the same blockchain 150 in their respective memory. Each blockchain node 104 also maintains an ordered set 154 of transactions 152 waiting to be incorporated into blocks 151. The ordered set 154 is often referred to as a “mempool”. This term herein is not intended to limit to any particular blockchain, protocol or model. It refers to the ordered set of transactions which a node 104 has accepted as valid and for which the node 104 is obliged not to accept any other transactions attempting to spend the same output.

In a given present transaction 152j, the (or each) input comprises a pointer referencing the output of a preceding transaction 152i in the sequence of transactions, specifying that this output is to be redeemed or “spent” in the present transaction 152j. In general, the preceding transaction could be any transaction in the ordered set 154 or any block 151. The preceding transaction 152i need not necessarily exist at the time the present transaction 152j is created or even sent to the network 106, though the preceding transaction 152i will need to exist and be validated in order for the present transaction to be valid. Hence “preceding” herein refers to a predecessor in a logical sequence linked by pointers, not necessarily the time of creation or sending in a temporal sequence, and hence it does not necessarily exclude that the transactions 152i, 152j be created or sent out-of-order (see discussion below on orphan transactions). The preceding transaction 152i could equally be called the antecedent or predecessor transaction.

The input of the present transaction 152j also comprises the input authorisation, for example the signature of the user 103a to whom the output of the preceding transaction 152i is locked. In turn, the output of the present transaction 152j can be cryptographically locked to a new user or entity 103b. The present transaction 152j can thus transfer the amount defined in the input of the preceding transaction 152i to the new user or entity 103b as defined in the output of the present transaction 152j. In some cases a transaction 152 may have multiple outputs to split the input amount between multiple users or entities (one of whom could be the original user or entity 103a in order to give change). In some cases a transaction can also have multiple inputs to gather together the amounts from multiple outputs of one or more preceding transactions, and redistribute to one or more outputs of the current transaction.

According to an output-based transaction protocol such as bitcoin, when an entity, such as a user or machine, 103 wishes to enact a new transaction 152j, then the entity sends the new transaction from its computer terminal 102 to a recipient. The entity or the recipient will eventually send this transaction to one or more of the blockchain nodes 104 of the network 106 (which nowadays are typically servers or data centres, but could in principle be other user terminals). It is also not excluded that the entity 103 enacting the new transaction 152j could send the transaction to one or more of the blockchain nodes 104 and, in some examples, not to the recipient. A blockchain node 104 that receives a transaction checks whether the transaction is valid according to a blockchain node protocol which is applied at each of the blockchain nodes 104. The blockchain node protocol typically requires the blockchain node 104 to check that a cryptographic signature in the new transaction 152j matches the expected signature, which depends on the previous transaction 152i in an ordered sequence of transactions 152. In such an output-based transaction protocol, this may comprise checking that the cryptographic signature or other authorisation of the entity 103 included in the input of the new transaction 152j matches a condition defined in the output of the preceding transaction 152i which the new transaction assigns, wherein this condition typically comprises at least checking that the cryptographic signature or other authorisation in the input of the new transaction 152j unlocks the output of the previous transaction 152i to which the input of the new transaction is linked to. The condition may be at least partially defined by a script included in the output of the preceding transaction 152i. Alternatively it could simply be fixed by the blockchain node protocol alone, or it could be due to a combination of these. Either way, if the new transaction 152j is valid, the blockchain node 104 forwards it to one or more other blockchain nodes 104 in the blockchain network 106. These other blockchain nodes 104 apply the same test according to the same blockchain node protocol, and so forward the new transaction 152j on to one or more further nodes 104, and so forth. In this way the new transaction is propagated throughout the network of blockchain nodes 104.

In an output-based model, the definition of whether a given output (e.g. UTXO) is assigned is whether it has yet been validly redeemed by the input of another, onward transaction 152j according to the blockchain node protocol. Another condition for a transaction to be valid is that the output of the preceding transaction 152i which it attempts to assign or redeem has not already been assigned/redeemed by another transaction. Again if not valid, the transaction 152j will not be propagated (unless flagged as invalid and propagated for alerting) or recorded in the blockchain 150. This guards against double-spending whereby the transactor tries to assign the output of the same transaction more than once. An account-based model on the other hand guards against double-spending by maintaining an account balance. Because again there is a defined order of transactions, the account balance has a single defined state at any one time.

In addition to validating transactions, blockchain nodes 104 also race to be the first to create blocks of transactions in a process commonly referred to as mining, which is supported by “proof-of-work”. At a blockchain node 104, new transactions are added to an ordered set 154 of valid transactions that have not yet appeared in a block 151 recorded on the blockchain 150. The blockchain nodes then race to assemble a new valid block 151 of transactions 152 from the ordered set of transactions 154 by attempting to solve a cryptographic puzzle. Typically this comprises searching for a “nonce” value such that when the nonce is concatenated with a representation of the ordered set of transactions 154 and hashed, then the output of the hash meets a predetermined condition. E.g. the predetermined condition may be that the output of the hash has a certain predefined number of leading zeros. Note that this is just one particular type of proof-of-work puzzle, and other types are not excluded. A property of a hash function is that it has an unpredictable output with respect to its input. Therefore this search can only be performed by brute force, thus consuming a substantive amount of processing resource at each blockchain node 104 that is trying to solve the puzzle.

The first blockchain node 104 to solve the puzzle announces this to the network 106, providing the solution as proof which can then be easily checked by the other blockchain nodes 104 in the network (once given the solution to a hash it is straightforward to check that it causes the output of the hash to meet the condition). The first blockchain node 104 propagates a block to a threshold consensus of other nodes that accept the block and thus enforce the protocol rules. The ordered set of transactions 154 then becomes recorded as a new block 151 in the blockchain 150 by each of the blockchain nodes 104. A block pointer 155 is also assigned to the new block 151n pointing back to the previously created block 151n-1 in the chain. A significant amount of effort, for example in the form of hash, required to create a proof-of-work solution signals the intent of the first node 104 to follow the rules of the blockchain protocol. Such rules include not accepting a transaction as valid if it assigns the same output as a previously validated transaction, otherwise known as double-spending. Once created, the block 151 cannot be modified since it is recognized and maintained at each of the blockchain nodes 104 in the blockchain network 106. The block pointer 155 also imposes a sequential order to the blocks 151. Since the transactions 152 are recorded in the ordered blocks at each blockchain node 104 in a network 106, this therefore provides an immutable public ledger of the transactions.

Note that different blockchain nodes 104 racing to solve the puzzle at any given time may be doing so based on different snapshots of the ordered set of yet to be published transactions 154 at any given time, depending on when they started searching for a solution or the order in which the transactions were received. Whoever solves their respective puzzle first defines which transactions 152 are included in the next new block 151n and in which order, and the current set 154 of unpublished transactions is updated. The blockchain nodes 104 then continue to race to create a block from the newly defined outstanding ordered set of unpublished transactions 154, and so forth. A protocol also exists for resolving any “fork” that may arise, which is where two blockchain nodes 104 solve their puzzle within a very short time of one another such that a conflicting view of the blockchain gets propagated between nodes 104. In short, whichever prong of the fork grows the longest becomes the definitive blockchain 150. Note this should not affect the users or agents of the network as the same transactions will appear in both forks.

According to the bitcoin blockchain (and most other blockchains) a node that successfully constructs a new block 104 is granted the ability to assign an accepted amount of the digital asset in a new special kind of transaction which distributes a defined quantity of the digital asset (as opposed to an inter-agent, or inter-user transaction which transfers an amount of the digital asset from one agent or user to another). This special type of transaction is usually referred to as a “coinbase transaction”, but may also be termed an “initiation transaction”. It typically forms the first transaction of the new block 151n. The proof-of-work signals the intent of the node that constructs the new block to follow the protocol rules allowing this special transaction to be redeemed later. The blockchain protocol rules may require a maturity period, for example 100 blocks, before this special transaction may be redeemed. Often a regular (non-generation) transaction 152 will also specify an additional transaction fee in one of its outputs, to further reward the blockchain node 104 that created the block 151n in which that transaction was published. This fee is normally referred to as the “transaction fee”, and is discussed blow.

Due to the resources involved in transaction validation and publication, typically at least each of the blockchain nodes 104 takes the form of a server comprising one or more physical server units, or even whole a data centre. However in principle any given blockchain node 104 could take the form of a user terminal or a group of user terminals networked together.

The memory of each blockchain node 104 stores software configured to run on the processing apparatus of the blockchain node 104 in order to perform its respective role or roles and handle transactions 152 in accordance with the blockchain node protocol. It will be understood that any action attributed herein to a blockchain node 104 may be performed by the software run on the processing apparatus of the respective computer equipment. The node software may be implemented in one or more applications at the application layer, or a lower layer such as the operating system layer or a protocol layer, or any combination of these.

Also connected to the network 101 is the computer equipment 102 of each of a plurality of parties 103 in the role of consuming users. These users may interact with the blockchain network but do not participate in validating, constructing or propagating transactions and blocks. Some of these users or agents 103 may act as senders and recipients in transactions. Other users may interact with the blockchain 150 without necessarily acting as senders or recipients. For instance, some parties may act as storage entities that store a copy of the blockchain 150 (e.g. having obtained a copy of the blockchain from a blockchain node 104).

Some or all of the parties 103 may be connected as part of a different network, e.g. a network overlaid on top of the blockchain network 106. Users of the blockchain network (often referred to as “clients”) may be said to be part of a system that includes the blockchain network; however, these users are not blockchain nodes 104 as they do not perform the roles required of the blockchain nodes. Instead, each party 103 may interact with the blockchain network 106 and thereby utilize the blockchain 150 by connecting to (i.e. communicating with) a blockchain node 106. Two parties 103 and their respective equipment 102 are shown for illustrative purposes: a first party 103a and his/her respective computer equipment 102a, and a second party 103b and his/her respective computer equipment 102b. It will be understood that many more such parties 103 and their respective computer equipment 102 may be present and participating in the system 100, but for convenience they are not illustrated. Each party 103 may be an individual or an organization. Purely by way of illustration the first party 103a is referred to herein as Alice and the second party 103b is referred to as Bob, but it will be appreciated that this is not limiting and any reference herein to Alice or Bob may be replaced with “first party” and “second “party” respectively.

The computer equipment 102 of each party 103 comprises respective processing apparatus comprising one or more processors, e.g. one or more CPUs, GPUs, other accelerator processors, application specific processors, and/or FPGAs. The computer equipment 102 of each party 103 further comprises memory, i.e. computer-readable storage in the form of a non-transitory computer-readable medium or media. This memory may comprise one or more memory units employing one or more memory media, e.g. a magnetic medium such as hard disk; an electronic medium such as an SSD, flash memory or EEPROM; and/or an optical medium such as an optical disc drive. The memory on the computer equipment 102 of each party 103 stores software comprising a respective instance of at least one client application 105 arranged to run on the processing apparatus. It will be understood that any action attributed herein to a given party 103 may be performed using the software run on the processing apparatus of the respective computer equipment 102. The computer equipment 102 of each party 103 comprises at least one user terminal, e.g. a desktop or laptop computer, a tablet, a smartphone, or a wearable device such as a smartwatch. The computer equipment 102 of a given party 103 may also comprise one or more other networked resources, such as cloud computing resources accessed via the user terminal.

The client application 105 may be initially provided to the computer equipment 102 of any given party 103 on suitable computer-readable storage medium or media, e.g. downloaded from a server, or provided on a removable storage device such as a removable SSD, flash memory key, removable EEPROM, removable magnetic disk drive, magnetic floppy disk or tape, optical disk such as a CD or DVD ROM, or a removable optical drive, etc.

The client application 105 comprises at least a “wallet” function. This has two main functionalities. One of these is to enable the respective party 103 to create, authorise (for example sign) and send transactions 152 to one or more bitcoin nodes 104 to then be propagated throughout the network of blockchain nodes 104 and thereby included in the blockchain 150. The other is to report back to the respective party the amount of the digital asset that he or she currently owns. In an output-based system, this second functionality comprises collating the amounts defined in the outputs of the various 152 transactions scattered throughout the blockchain 150 that belong to the party in question.

Note: whilst the various client functionality may be described as being integrated into a given client application 105, this is not necessarily limiting and instead any client functionality described herein may instead be implemented in a suite of two or more distinct applications, e.g. interfacing via an API, or one being a plug-in to the other. More generally the client functionality could be implemented at the application layer or a lower layer such as the operating system, or any combination of these. The following will be described in terms of a client application 105 but it will be appreciated that this is not limiting.

The instance of the client application or software 105 on each computer equipment 102 is operatively coupled to at least one of the blockchain nodes 104 of the network 106. This enables the wallet function of the client 105 to send transactions 152 to the network 106.

The client 105 is also able to contact blockchain nodes 104 in order to query the blockchain 150 for any transactions of which the respective party 103 is the recipient (or indeed inspect other parties' transactions in the blockchain 150, since in embodiments the blockchain 150 is a public facility which provides trust in transactions in part through its public visibility). The wallet function on each computer equipment 102 is configured to formulate and send transactions 152 according to a transaction protocol. As set out above, each blockchain node 104 runs software configured to validate transactions 152 according to the blockchain node protocol, and to forward transactions 152 in order to propagate them throughout the blockchain network 106. The transaction protocol and the node protocol correspond to one another, and a given transaction protocol goes with a given node protocol, together implementing a given transaction model. The same transaction protocol is used for all transactions 152 in the blockchain 150. The same node protocol is used by all the nodes 104 in the network 106.

When a given party 103, say Alice, wishes to send a new transaction 152j to be included in the blockchain 150, then she formulates the new transaction in accordance with the relevant transaction protocol (using the wallet function in her client application 105). She then sends the transaction 152 from the client application 105 to one or more blockchain nodes 104 to which she is connected. E.g. this could be the blockchain node 104 that is best connected to Alice's computer 102. When any given blockchain node 104 receives a new transaction 152j, it handles it in accordance with the blockchain node protocol and its respective role. This comprises first checking whether the newly received transaction 152j meets a certain condition for being “valid”, examples of which will be discussed in more detail shortly. In some transaction protocols, the condition for validation may be configurable on a per-transaction basis by scripts included in the transactions 152. Alternatively the condition could simply be a built-in feature of the node protocol, or be defined by a combination of the script and the node protocol.

On condition that the newly received transaction 152j passes the test for being deemed valid (i.e. on condition that it is “validated”), any blockchain node 104 that receives the transaction 152j will add the new validated transaction 152 to the ordered set of transactions 154 maintained at that blockchain node 104. Further, any blockchain node 104 that receives the transaction 152j will propagate the validated transaction 152 onward to one or more other blockchain nodes 104 in the network 106. Since each blockchain node 104 applies the same protocol, then assuming the transaction 152j is valid, this means it will soon be propagated throughout the whole network 106.

Once admitted to the ordered set of transactions 154 maintained at a given blockchain node 104, that blockchain node 104 will start competing to solve the proof-of-work puzzle on the latest version of their respective ordered set of transactions 154 including the new transaction 152 (recall that other blockchain nodes 104 may be trying to solve the puzzle based on a different ordered set of transactions 154, but whoever gets there first will define the ordered set of transactions that are included in the latest block 151. Eventually a blockchain node 104 will solve the puzzle for a part of the ordered set 154 which includes Alice's transaction 152j). Once the proof-of-work has been done for the ordered set 154 including the new transaction 152j, it immutably becomes part of one of the blocks 151 in the blockchain 150. Each transaction 152 comprises a pointer back to an earlier transaction, so the order of the transactions is also immutably recorded.

Different blockchain nodes 104 may receive different instances of a given transaction first and therefore have conflicting views of which instance is ‘valid’ before one instance is published in a new block 151, at which point all blockchain nodes 104 agree that the published instance is the only valid instance. If a blockchain node 104 accepts one instance as valid, and then discovers that a second instance has been recorded in the blockchain 150 then that blockchain node 104 must accept this and will discard (i.e. treat as invalid) the instance which it had initially accepted (i.e. the one that has not been published in a block 151).

An alternative type of transaction protocol operated by some blockchain networks may be referred to as an “account-based” protocol, as part of an account-based transaction model. In the account-based case, each transaction does not define the amount to be transferred by referring back to the UTXO of a preceding transaction in a sequence of past transactions, but rather by reference to an absolute account balance. The current state of all accounts is stored, by the nodes of that network, separate to the blockchain and is updated constantly. In such a system, transactions are ordered using a running transaction tally of the account (also called the “position”). This value is signed by the sender as part of their cryptographic signature and is hashed as part of the transaction reference calculation. In addition, an optional data field may also be signed the transaction. This data field may point back to a previous transaction, for example if the previous transaction ID is included in the data field.

### UTXO-Based Model

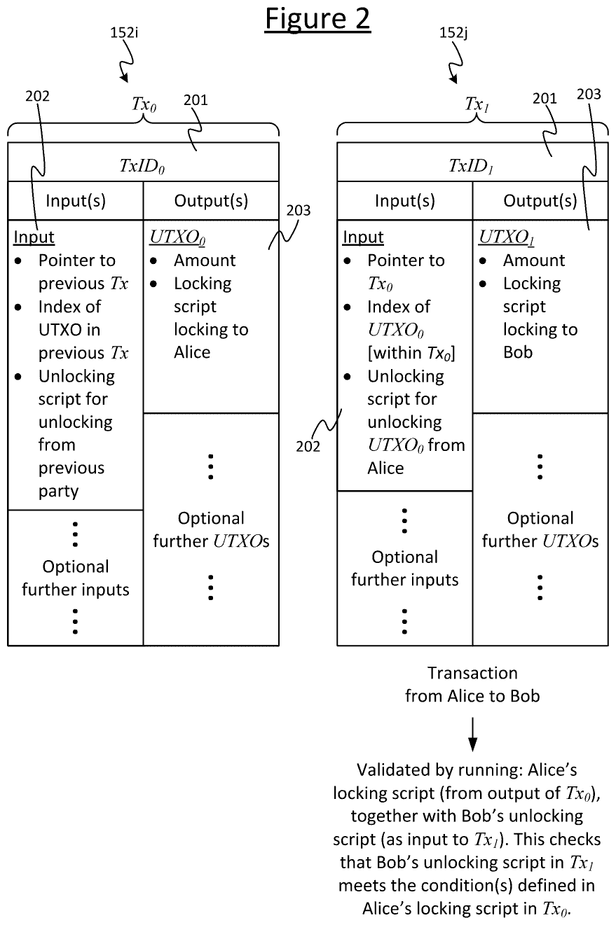

FIG. 2 illustrates an example transaction protocol. This is an example of a UTXO-based protocol. A transaction 152 (abbreviated “Tx”) is the fundamental data structure of the blockchain 150 (each block 151 comprising one or more transactions 152). The following will be described by reference to an output-based or “UTXO” based protocol. However, this is not limiting to all possible embodiments. Note that while the example UTXO-based protocol is described with reference to bitcoin, it may equally be implemented on other example blockchain networks.

In a UTXO-based model, each transaction (“Tx”) 152 comprises a data structure comprising one or more inputs 202, and one or more outputs 203. Each output 203 may comprise an unspent transaction output (UTXO), which can be used as the source for the input 202 of another new transaction (if the UTXO has not already been redeemed). The UTXO includes a value specifying an amount of a digital asset. This represents a set number of tokens on the distributed ledger. The UTXO may also contain the transaction ID of the transaction from which it came, amongst other information. The transaction data structure may also comprise a header 201, which may comprise an indicator of the size of the input field(s) 202 and output field(s) 203. The header 201 may also include an ID of the transaction. In embodiments the transaction ID is the hash of the transaction data (excluding the transaction ID itself) and stored in the header 201 of the raw transaction 152 submitted to the nodes 104.

Say Alice 103a wishes to create a transaction 152j transferring an amount of the digital asset in question to Bob 103b. In FIG. 2 Alice's new transaction 152j is labelled “Tx₁”. It takes an amount of the digital asset that is locked to Alice in the output 203 of a preceding transaction 152i in the sequence, and transfers at least some of this to Bob. The preceding transaction 152i is labelled “Tx₀” in FIG. 2. Tx₀ and Tx₁ are just arbitrary labels. They do not necessarily mean that Tx₀ is the first transaction in the blockchain 151, nor that Tx₁ is the immediate next transaction in the pool 154. Tx₁ could point back to any preceding (i.e. antecedent) transaction that still has an unspent output 203 locked to Alice.

The preceding transaction Tx₀ may already have been validated and included in a block 151 of the blockchain 150 at the time when Alice creates her new transaction Tx₁, or at least by the time she sends it to the network 106. It may already have been included in one of the blocks 151 at that time, or it may be still waiting in the ordered set 154 in which case it will soon be included in a new block 151. Alternatively Tx₀ and Tx₁ could be created and sent to the network 106 together, or Tx₀ could even be sent after Tx₁ if the node protocol allows for buffering “orphan” transactions. The terms “preceding” and “subsequent” as used herein in the context of the sequence of transactions refer to the order of the transactions in the sequence as defined by the transaction pointers specified in the transactions (which transaction points back to which other transaction, and so forth). They could equally be replaced with “predecessor” and “successor”, or “antecedent” and “descendant”, “parent” and “child”, or such like. It does not necessarily imply an order in which they are created, sent to the network 106, or arrive at any given blockchain node 104. Nevertheless, a subsequent transaction (the descendent transaction or “child”) which points to a preceding transaction (the antecedent transaction or “parent”) will not be validated until and unless the parent transaction is validated. A child that arrives at a blockchain node 104 before its parent is considered an orphan. It may be discarded or buffered for a certain time to wait for the parent, depending on the node protocol and/or node behaviour.

One of the one or more outputs 203 of the preceding transaction Tx₀ comprises a particular UTXO, labelled here UTXO₀. Each UTXO comprises a value specifying an amount of the digital asset represented by the UTXO, and a locking script which defines a condition which must be met by an unlocking script in the input 202 of a subsequent transaction in order for the subsequent transaction to be validated, and therefore for the UTXO to be successfully redeemed. Typically the locking script locks the amount to a particular party (the beneficiary of the transaction in which it is included). I.e. the locking script defines an unlocking condition, typically comprising a condition that the unlocking script in the input of the subsequent transaction comprises the cryptographic signature of the party to whom the preceding transaction is locked.

The locking script (aka scriptPubKey) is a piece of code written in the domain specific language recognized by the node protocol. A particular example of such a language is called “Script” (capital S) which is used by the blockchain network. The locking script specifies what information is required to spend a transaction output 203, for example the requirement of Alice's signature. Unlocking scripts appear in the outputs of transactions. The unlocking script (aka scriptSig) is a piece of code written the domain specific language that provides the information required to satisfy the locking script criteria. For example, it may contain Bob's signature. Unlocking scripts appear in the input 202 of transactions.

So in the example illustrated, UTXO₀ in the output 203 of Tx₀ comprises a locking script [Checksig P_{A}] which requires a signature Sig P_{A} of Alice in order for UTXO₀ to be redeemed (strictly, in order for a subsequent transaction attempting to redeem UTXO₀ to be valid). [Checksig P_{A}] contains a representation (i.e. a hash) of the public key P_{A} from a public-private key pair of Alice. The input 202 of Tx₁ comprises a pointer pointing back to Tx₁ (e.g. by means of its transaction ID, TxID₀, which in embodiments is the hash of the whole transaction Tx₀). The input 202 of Tx₁ comprises an index identifying UTXO₀ within Tx₀, to identify it amongst any other possible outputs of Tx₀. The input 202 of Tx₁ further comprises an unlocking script <Sig P_{A}> which comprises a cryptographic signature of Alice, created by Alice applying her private key from the key pair to a predefined portion of data (sometimes called the “message” in cryptography). The data (or “message”) that needs to be signed by Alice to provide a valid signature may be defined by the locking script, or by the node protocol, or by a combination of these.

When the new transaction Tx₁ arrives at a blockchain node 104, the node applies the node protocol. This comprises running the locking script and unlocking script together to check whether the unlocking script meets the condition defined in the locking script (where this condition may comprise one or more criteria). In embodiments this involves concatenating the two scripts:

<Sig P_{A}><P_{A}>∥[Checksig P_{A}]

where “∥” represents a concatenation and “< . . . >” means place the data on the stack, and “[ . . . ]” is a function comprised by the locking script (in this example a stack-based language). Preferably, the “< >” characters indicate that the contents within the angle brackets are PUSHDATA encoded. PUSHDATA encoding relates to the usage of the OP_PUSHDATA opcodes to add data to the stack. Equivalently the scripts may be run one after the other, with a common stack, rather than concatenating the scripts. Either way, when run together, the scripts use the public key P_{A} of Alice, as included in the locking script in the output of Tx₀, to authenticate that the unlocking script in the input of Tx₁ contains the signature of Alice signing the expected portion of data. The expected portion of data itself (the “message”) also needs to be included in order to perform this authentication. In embodiments the signed data comprises the whole of Tx₁ (so a separate element does not need to be included specifying the signed portion of data in the clear, as it is already inherently present).

The details of authentication by public-private cryptography will be familiar to a person skilled in the art. Basically, if Alice has signed a message using her private key, then given Alice's public key and the message in the clear, another entity such as a node 104 is able to authenticate that the message must have been signed by Alice. Signing typically comprises hashing the message, signing the hash, and tagging this onto the message as a signature, thus enabling any holder of the public key to authenticate the signature. Note therefore that any reference herein to signing a particular piece of data or part of a transaction, or such like, can in embodiments mean signing a hash of that piece of data or part of the transaction.

If the unlocking script in Tx₁ meets the one or more conditions specified in the locking script of Tx₀ (so in the example shown, if Alice's signature is provided in Tx₁ and authenticated), then the blockchain node 104 deems Tx₁ valid. This means that the blockchain node 104 will add Tx₁ to the ordered set of transactions 154. The blockchain node 104 will also forward the transaction Tx₁ to one or more other blockchain nodes 104 in the network 106, so that it will be propagated throughout the network 106. Once Tx₁ has been validated and included in the blockchain 150, this defines UTXO₀ from Tx₀ as spent. Note that Tx₁ can only be valid if it spends an unspent transaction output 203. If it attempts to spend an output that has already been spent by another transaction 152, then Tx₁ will be invalid even if all the other conditions are met. Hence the blockchain node 104 also needs to check whether the referenced UTXO in the preceding transaction Tx₀ is already spent (i.e. whether it has already formed a valid input to another valid transaction). This is one reason why it is important for the blockchain 150 to impose a defined order on the transactions 152. In practice a given blockchain node 104 may maintain a separate database marking which UTXOs 203 in which transactions 152 have been spent, but ultimately what defines whether a UTXO has been spent is whether it has already formed a valid input to another valid transaction in the blockchain 150.

If the total amount specified in all the outputs 203 of a given transaction 152 is greater than the total amount pointed to by all its inputs 202, this is another basis for invalidity in most transaction models. Therefore such transactions will not be propagated nor included in a block 151.

Note that in UTXO-based transaction models, a given UTXO needs to be spent as a whole.

It cannot “leave behind” a fraction of the amount defined in the UTXO as spent while another fraction is spent. However the amount from the UTXO can be split between multiple outputs of the next transaction. E.g. the amount defined in UTXO₀ in Tx₀ can be split between multiple UTXOs in Tx₁. Hence if Alice does not want to give Bob all of the amount defined in UTXO₀, she can use the remainder to give herself change in a second output of Tx₁, or pay another party.

In practice Alice will also usually need to include a fee for the bitcoin node that publishes her transaction 104. If Alice does not include such a fee, Tx₀ may be rejected by the blockchain nodes 104, and hence although technically valid, may not be propagated and included in the blockchain 150 (the node protocol does not force blockchain nodes 104 to accept transactions 152 if they don't want). In some protocols, the transaction fee does not require its own separate output 203 (i.e. does not need a separate UTXO). Instead any difference between the total amount pointed to by the input(s) 202 and the total amount of specified in the output(s) 203 of a given transaction 152 is automatically given to the blockchain node 104 publishing the transaction. E.g. say a pointer to UTXO₀ is the only input to Tx₁, and Tx₁ has only one output UTXO₁. If the amount of the digital asset specified in UTXO₀ is greater than the amount specified in UTXO₁, then the difference may be assigned by the node 104 that publishes the block containing UTXO₁. Alternatively or additionally however, it is not necessarily excluded that a transaction fee could be specified explicitly in its own one of the UTXOs 203 of the transaction 152.

Alice and Bob's digital assets consist of the UTXOs locked to them in any transactions 152 anywhere in the blockchain 150. Hence typically, the assets of a given party 103 are scattered throughout the UTXOs of various transactions 152 throughout the blockchain 150. There is no one number stored anywhere in the blockchain 150 that defines the total balance of a given party 103. It is the role of the wallet function in the client application 105 to collate together the values of all the various UTXOs which are locked to the respective party and have not yet been spent in another onward transaction. It can do this by querying the copy of the blockchain 150 as stored at any of the bitcoin nodes 104.

Note that the script code is often represented schematically (i.e. not using the exact language). For example, one may use operation codes (opcodes) to represent a particular function. “OP_. . . ” refers to a particular opcode of the Script language. As an example, OP_RETURN is an opcode of the Script language that when preceded by OP_FALSE at the beginning of a locking script creates an unspendable output of a transaction that can store data within the transaction, and thereby record the data immutably in the blockchain 150. E.g. the data could comprise a document which it is desired to store in the blockchain.

Typically an input of a transaction contains a digital signature corresponding to a public key P_{A}. In embodiments this is based on the ECDSA using the elliptic curve secp256k1. A digital signature signs a particular piece of data. In some embodiments, for a given transaction the signature will sign part of the transaction input, and some or all of the transaction outputs. The particular parts of the outputs it signs depends on the SIGHASH flag. The SIGHASH flag is usually a 4-byte code included at the end of a signature to select which outputs are signed (and thus fixed at the time of signing).

The locking script is sometimes called “scriptPubKey” referring to the fact that it typically comprises the public key of the party to whom the respective transaction is locked. The unlocking script is sometimes called “scriptSig” referring to the fact that it typically supplies the corresponding signature. However, more generally it is not essential in all applications of a blockchain 150 that the condition for a UTXO to be redeemed comprises authenticating a signature. More generally the scripting language could be used to define any one or more conditions. Hence the more general terms “locking script” and “unlocking script” may be preferred.

As shown in FIG. 1, the client application on each of Alice and Bob's computer equipment 102a, 120b, respectively, may comprise additional communication functionality. This additional functionality enables Alice 103a to establish a separate side channel 301 with Bob 103b (at the instigation of either party or a third party). The side channel 301 enables exchange of data separately from the blockchain network. Such communication is sometimes referred to as “off-chain” communication. For instance this may be used to exchange a transaction 152 between Alice and Bob without the transaction (yet) being registered onto the blockchain network 106 or making its way onto the chain 150, until one of the parties chooses to broadcast it to the network 106. Sharing a transaction in this way is sometimes referred to as sharing a “transaction template”. A transaction template may lack one or more inputs and/or outputs that are required in order to form a complete transaction. Alternatively or additionally, the side channel 301 may be used to exchange any other transaction related data, such as keys, negotiated amounts or terms, data content, etc.

The side channel 301 may be established via the same packet-switched network 101 as the blockchain network 106. Alternatively or additionally, the side channel 301 may be established via a different network such as a mobile cellular network, or a local area network such as a local wireless network, or even a direct wired or wireless link between Alice and Bob's devices 102a, 102b. Generally, the side channel 301 as referred to anywhere herein may comprise any one or more links via one or more networking technologies or communication media for exchanging data “off-chain”, i.e. separately from the blockchain network 106. Where more than one link is used, then the bundle or collection of off-chain links as a whole may be referred to as the side channel 301. Note therefore that if it is said that Alice and Bob exchange certain pieces of information or data, or such like, over the side channel 301, then this does not necessarily imply all these pieces of data have to be send over exactly the same link or even the same type of network.

### Client Software

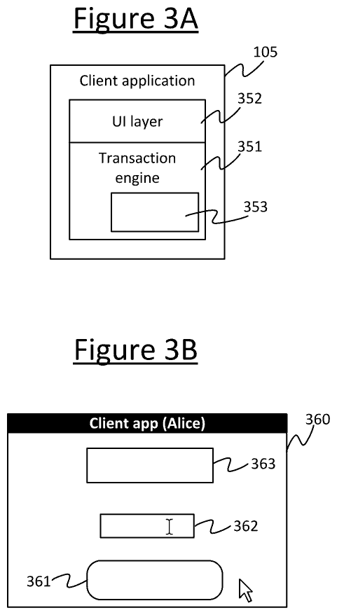

FIG. 3A illustrates an example implementation of the client application 105 for implementing embodiments of the presently disclosed scheme. The client application 105 comprises a transaction engine 351 and a user interface (UI) layer 352. The transaction engine 351 is configured to implement the underlying transaction-related functionality of the client 105, such as to formulate transactions 152, receive and/or send transactions and/or other data over the side channel 301, and/or send transactions to one or more nodes 104 to be propagated through the blockchain network 106, in accordance with the schemes discussed above and as discussed in further detail shortly. In accordance with embodiments disclosed herein, the transaction engine 351 of each client 105 comprises a function 353 . . . .

The UI layer 352 is configured to render a user interface via a user input/output (I/O) means of the respective user's computer equipment 102, including outputting information to the respective user 103 via a user output means of the equipment 102, and receiving inputs back from the respective user 103 via a user input means of the equipment 102. For example the user output means could comprise one or more display screens (touch or non-touch screen) for providing a visual output, one or more speakers for providing an audio output, and/or one or more haptic output devices for providing a tactile output, etc. The user input means could comprise for example the input array of one or more touch screens (the same or different as that/those used for the output means); one or more cursor-based devices such as mouse, trackpad or trackball; one or more microphones and speech or voice recognition algorithms for receiving a speech or vocal input; one or more gesture-based input devices for receiving the input in the form of manual or bodily gestures; or one or more mechanical buttons, switches or joysticks, etc.

Note: whilst the various functionality herein may be described as being integrated into the same client application 105, this is not necessarily limiting and instead they could be implemented in a suite of two or more distinct applications, e.g. one being a plug-in to the other or interfacing via an API (application programming interface). For instance, the functionality of the transaction engine 351 may be implemented in a separate application than the UI layer 352, or the functionality of a given module such as the transaction engine 351 could be split between more than one application. Nor is it excluded that some or all of the described functionality could be implemented at, say, the operating system layer. Where reference is made anywhere herein to a single or given application 105, or such like, it will be appreciated that this is just by way of example, and more generally the described functionality could be implemented in any form of software.

FIG. 3B gives a mock-up of an example of the user interface (UI) 360 which may be rendered by the UI layer 352 of the client application 105a on Alice's equipment 102a. It will be appreciated that a similar UI may be rendered by the client 105b on Bob's equipment 102b, or that of any other party.

By way of illustration FIG. 3B shows the UI 360 from Alice's perspective. The UI 360 may comprise one or more UI elements 362, 362, 363 rendered as distinct UI elements via the user output means.

For example, the UI elements may comprise one or more user-selectable elements 362 which may be, such as different on-screen buttons, or different options in a menu, or such like. The user input means is arranged to enable the user 103 (in this case Alice 103a) to select or otherwise operate one of the options, such as by clicking or touching the UI element on-screen, or speaking a name of the desired option (N.B. the term “manual” as used herein is meant only to contrast against automatic, and does not necessarily limit to the use of the hand or hands).

Alternatively or additionally, the UI elements may comprise one or more data entry fields 362, through which the user can . . . . These data entry fields are rendered via the user output means, e.g. on-screen, and the data can be entered into the fields through the user input means, e.g. a keyboard or touchscreen. Alternatively the data could be received orally for example based on speech recognition.

Alternatively or additionally, the UI elements may comprise one or more information elements 363 output to output information to the user. E.g. this/these could be rendered on screen or audibly.

It will be appreciated that the particular means of rendering the various UI elements, selecting the options and entering data is not material. The functionality of these UI elements will be discussed in more detail shortly. It will also be appreciated that the UI 360 shown in FIG. 3 is only a schematized mock-up and in practice it may comprise one or more further UI elements, which for conciseness are not illustrated.

### Node Software

FIG. 4 illustrates an example of the node software 450 that is run on each blockchain node 104 of the network 106, in the example of a UTXO- or output-based model. Note that another entity may run node software 450 without being classed as a node 104 on the network 106, i.e. without performing the actions required of a node 104. The node software 450 may contain, but is not limited to, a protocol engine 451, a script engine 452, a stack 453, an application-level decision engine 454, and a set of one or more blockchain-related functional modules 455. Each node 104 may run node software that contains, but is not limited to, all three of: a consensus module 455C (for example, proof-of-work), a propagation module 455P and a storage module 455S (for example, a database). The protocol engine 351 is typically configured to recognize the different fields of a transaction 152 and process them in accordance with the node protocol. When a transaction 152j (Txⱼ) is received having an input pointing to an output (e.g. UTXO) of another, preceding transaction 152i (Txₘ₋₁), then the protocol engine 451 identifies the unlocking script in Txⱼ and passes it to the script engine 452. The protocol engine 451 also identifies and retrieves Txᵢ based on the pointer in the input of Txⱼ. Txᵢ may be published on the blockchain 150, in which case the protocol engine may retrieve Txᵢ from a copy of a block 151 of the blockchain 150 stored at the node 104. Alternatively, Txᵢ may yet to have been published on the blockchain 150. In that case, the protocol engine 451 may retrieve Txᵢ from the ordered set 154 of unpublished transactions maintained by the node 104. Either way, the script engine 451 identifies the locking script in the referenced output of Txᵢ and passes this to the script engine 452.

The script engine 452 thus has the locking script of Txᵢ and the unlocking script from the corresponding input of Txⱼ. For example, transactions labelled Tx₀ and Tx₁ are illustrated in FIG. 2, but the same could apply for any pair of transactions. The script engine 452 runs the two scripts together as discussed previously, which will include placing data onto and retrieving data from the stack 453 in accordance with the stack-based scripting language being used (e.g. Script).

By running the scripts together, the script engine 452 determines whether or not the unlocking script meets the one or more criteria defined in the locking script—i.e. does it “unlock” the output in which the locking script is included? The script engine 452 returns a result of this determination to the protocol engine 451. If the script engine 452 determines that the unlocking script does meet the one or more criteria specified in the corresponding locking script, then it returns the result “true”. Otherwise it returns the result “false”.

In an output-based model, the result “true” from the script engine 452 is one of the conditions for validity of the transaction. Typically there are also one or more further, protocol-level conditions evaluated by the protocol engine 451 that must be met as well; such as that the total amount of digital asset specified in the output(s) of Txⱼ does not exceed the total amount pointed to by its inputs, and that the pointed-to output of Txᵢ has not already been spent by another valid transaction. The protocol engine 451 evaluates the result from the script engine 452 together with the one or more protocol-level conditions, and only if they are all true does it validate the transaction Txⱼ. The protocol engine 451 outputs an indication of whether the transaction is valid to the application-level decision engine 454. Only on condition that Txⱼ is indeed validated, the decision engine 454 may select to control both of the consensus module 455C and the propagation module 455P to perform their respective blockchain-related function in respect of Txⱼ. This comprises the consensus module 455C adding Txⱼ to the node's respective ordered set of transactions 154 for incorporating in a block 151, and the propagation module 455P forwarding Txⱼ to another blockchain node 104 in the network 106. Optionally, in embodiments the application-level decision engine 454 may apply one or more additional conditions before triggering either or both of these functions. E.g. the decision engine may only select to publish the transaction on condition that the transaction is both valid and leaves enough of a transaction fee.

Note also that the terms “true” and “false” herein do not necessarily limit to returning a result represented in the form of only a single binary digit (bit), though that is certainly one possible implementation. More generally, “true” can refer to any state indicative of a successful or affirmative outcome, and “false” can refer to any state indicative of an unsuccessful or non-affirmative outcome. For instance in an account-based model, a result of “true” could be indicated by a combination of an implicit, protocol-level validation of a signature and an additional affirmative output of a smart contract (the overall result being deemed to signal true if both individual outcomes are true).

Other variants or use cases of the disclosed techniques may become apparent to the person skilled in the art once given the disclosure herein. The scope of the disclosure is not limited by the described embodiments but only by the accompanying claims.

For instance, some embodiments above have been described in terms of a bitcoin network 106, bitcoin blockchain 150 and bitcoin nodes 104. However it will be appreciated that the bitcoin blockchain is one particular example of a blockchain 150 and the above description may apply generally to any blockchain. That is, the present invention is in by no way limited to the bitcoin blockchain. More generally, any reference above to bitcoin network 106, bitcoin blockchain 150 and bitcoin nodes 104 may be replaced with reference to a blockchain network 106, blockchain 150 and blockchain node 104 respectively. The blockchain, blockchain network and/or blockchain nodes may share some or all of the described properties of the bitcoin blockchain 150, bitcoin network 106 and bitcoin nodes 104 as described above.

In preferred embodiments of the invention, the blockchain network 106 is the bitcoin network and bitcoin nodes 104 perform at least all of the described functions of creating, publishing, propagating and storing blocks 151 of the blockchain 150. It is not excluded that there may be other network entities (or network elements) that only perform one or some but not all of these functions. That is, a network entity may perform the function of propagating and/or storing blocks without creating and publishing blocks (recall that these entities are not considered nodes of the preferred bitcoin network 106).

In non-preferred embodiments of the invention, the blockchain network 106 may not be the bitcoin network. In these embodiments, it is not excluded that a node may perform at least one or some but not all of the functions of creating, publishing, propagating and storing blocks 151 of the blockchain 150. For instance, on those other blockchain networks a “node” may be used to refer to a network entity that is configured to create and publish blocks 151 but not store and/or propagate those blocks 151 to other nodes.

Even more generally, any reference to the term “bitcoin node” 104 above may be replaced with the term “network entity” or “network element”, wherein such an entity/element is configured to perform some or all of the roles of creating, publishing, propagating and storing blocks. The functions of such a network entity/element may be implemented in hardware in the same way described above with reference to a blockchain node 104.

### Ordered, Append-Only Data Storage

The use of the blockchain for high-volume, data-oriented applications has increased significantly in recent years. With this increase, the demand for robust layer-2 protocols for structuring, encoding and formatting the data payloads that are published to the blockchain has also increased commensurately. Here, layer-2 means secondary protocols, frameworks, data structures etc that are built on top of an existing blockchain system or systems. The aspects described herein would be considered as layer-2 protocols. Layer-1 would refer to Bitcoin, Bitcoin SV, or other underlying blockchain technologies.

It is typical for blockchain-based applications involving large amounts of data to require a data schema or structuring mechanism that allows many data-carrier transactions to be linked to one another. This is particularly pertinent to applications (e.g. in supply chains) where many events and/or data may need to be linked to each other in a linearised sequence.

The maintenance and tracking of a sequence of events and/or ordered data items can be aided by unique references, whereby one data-carrier transaction will explicitly reference another to ensure that the two transactions can be related to one another by an observer of the blockchain.

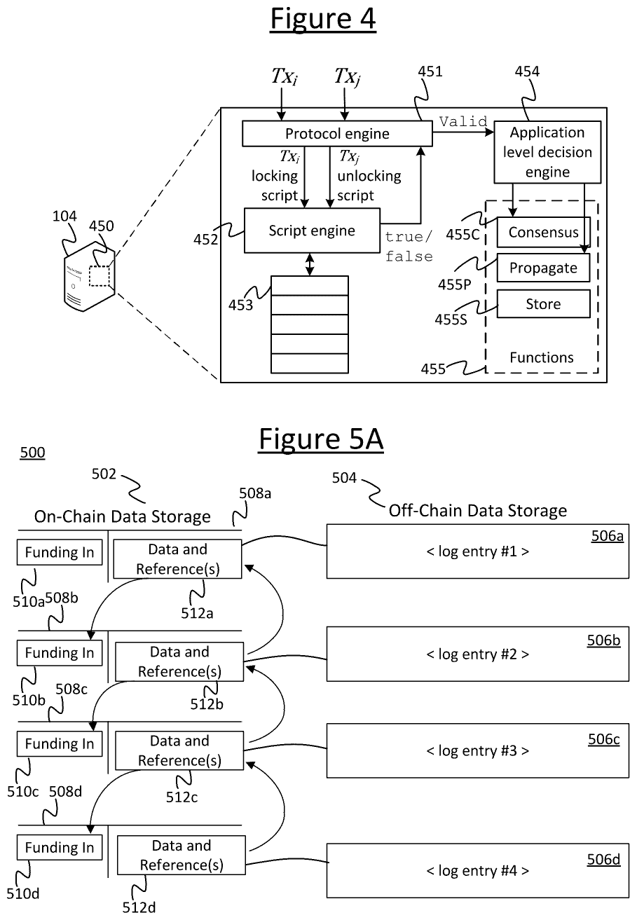

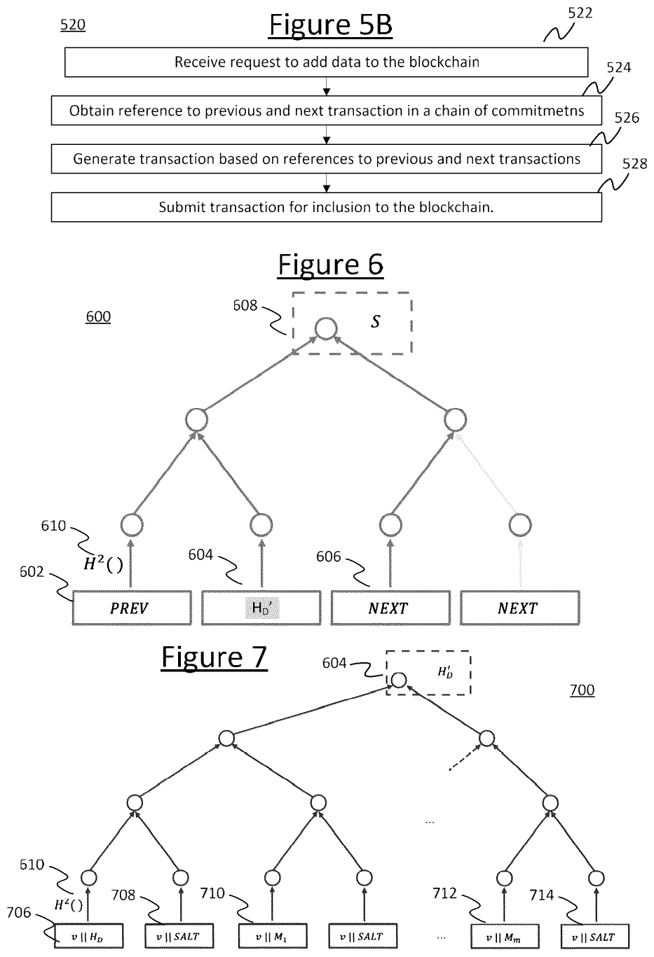

FIG. 5A relates to a first aspect of the present disclosure and illustrates an overview of the data structure and paradigm of an ordered, append-only data storage system. This can also be described as a data logging system. The system 500 comprises an off-chain (i.e. not on a blockchain) data storage system 504 storing a number of log entries 506a-d. These log entries are reflected on-chain 502 through use of blockchain transactions 508a-d. The off-chain data storage system is preferably a database. A skilled person will appreciate that any data storage system may be used alternatively including storage on a hard drive.

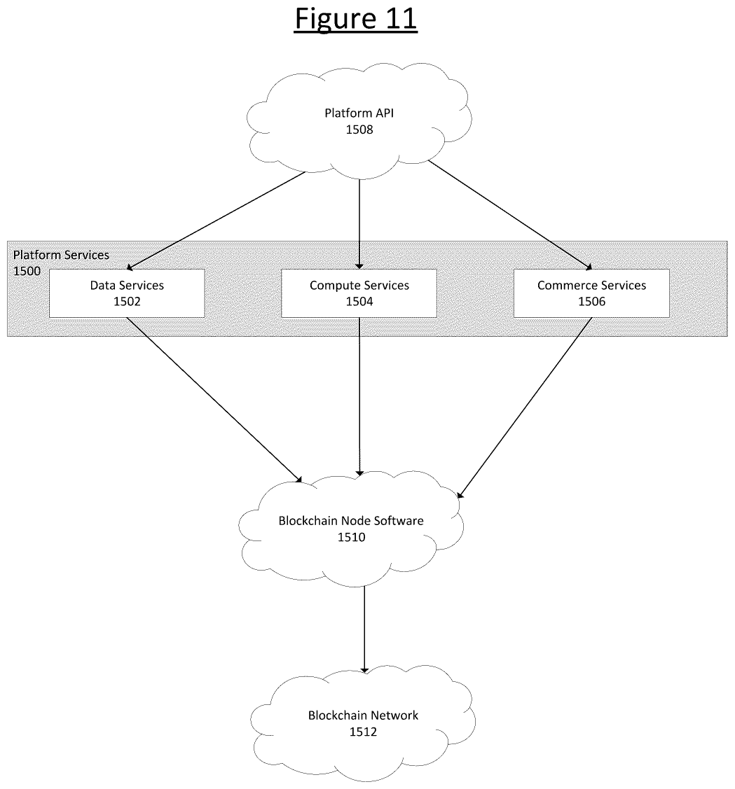

The system 500 of FIG. 5A is preferably used as part of an Event Stream system for logging events. Mapping each event to a transaction is shown as an example. Optionally only a subset of the events in the append-only log are mapped to a blockchain transaction. By way of example, the Event Stream is used throughout the specification for illustrative purposes. In particular FIGS. 11 to 13 provide specific examples of the different servers and services operating within the Event Stream system that would receive the client data, construct the transactions, and submit it to a blockchain. A skilled person will appreciate that the proposed embodiments described herein may be used with any client data items, not only those associated with an Event Stream. A skilled person will appreciate that in-order, append-only, blockchain-based, logging (or data storage) methods and systems may be used for other purposes also.

Each event 506a-d in the off-chain data storage 504 is mapped to a blockchain transaction 508a-d, and the sequence of blockchain transactions are ordered and linked using a ‘chain of commitments’. A chain of commitments can be viewed as a set of transactions that comprise information such that they can be associated with each other and/or traversable. As described herein, the set of transactions is constructed as a “chain” in that each transaction comprises (or comprises data that is based on) a reference to a previous transaction and a reference to a next transaction. Preferably, it is the payload 512a-d of each transaction that comprises or is based on a reference to a previous transaction and a next transaction.

Each transaction preferably comprises a “funding in” input 510a-d to pay for the transaction to be mined into a block on the blockchain. Each transaction preferably comprises a data payload 512a-d. The data payload is held in an un-spendable output of the transaction. Preferably the output is prepended with an OP_RETURN opcode. This is a Script opcode which can be used to write arbitrary data on a blockchain and also to mark a transaction output as invalid (i.e. un-spendable), and thereby recording the data immutably on the blockchain. Optionally, the data payload is prepended with OP_0 and OP_RETURN Script opcodes.

Referring to FIG. 5B, an example method 520 of adding a transaction to a blockchain where the transaction is part of a set of transactions and in particular the set is a chain of commitments.

In the first step, a request is received 522 to add data to the blockchain. In particular for this example, the request triggers the addition of a transaction to a chain of commitments as described herein, if the chain of commitments has not been created yet, then optionally this also creates the chain of commitments. Preferably, the request is from a client wishing for a representation of the data to be stored on the blockchain and more preferably, a hash of the client data is to be stored on the blockchain. Alternatively, the request is from a client wishing to establish an event stream off-chain thereby triggering an on-chain representation of the event stream in the form of a chain of commitment.

Next, a reference to a previous and next transaction are obtained 524. These references, as described below under their respective headings “Previous Transaction Reference” and “Next Transaction Reference”, are based on components of said transactions.

With the references obtained, a transaction is generated 526 based on the references. The transaction preferably comprises a state digest as described below under its respective heading “State Digest (S)”. Optionally, the transaction is also based on data received from a client as described below under its respective heading “Data Digest (H)”.

The transaction is then submitted 528 for inclusion to the blockchain.

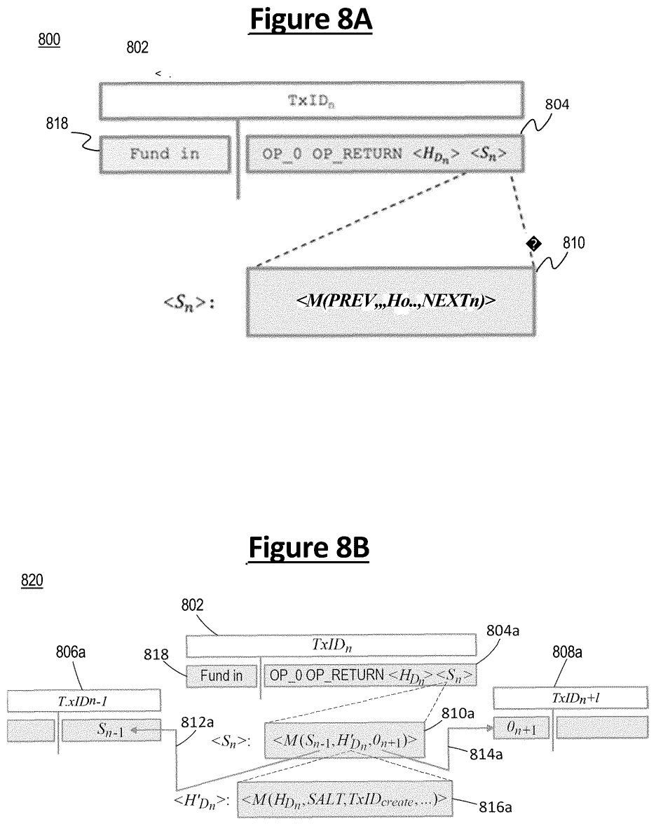

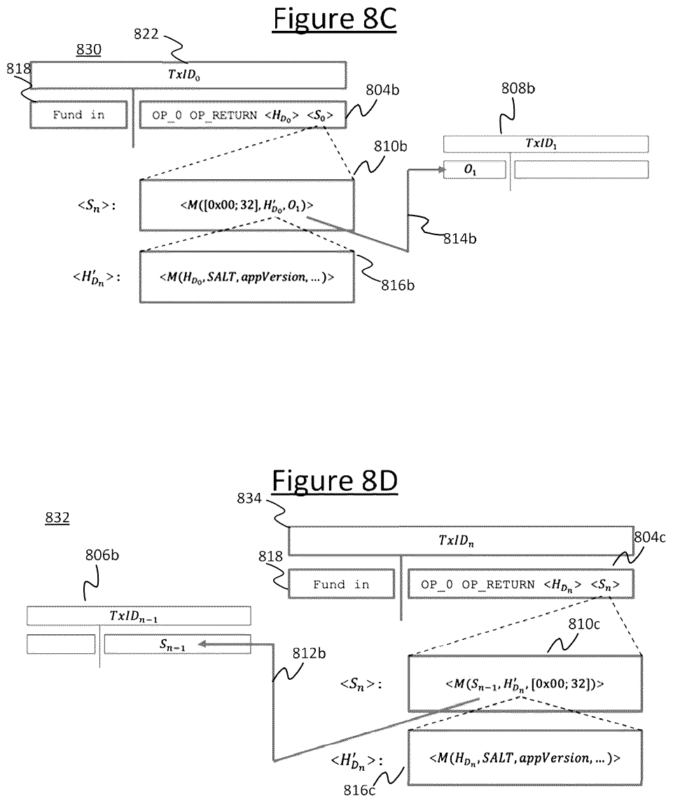

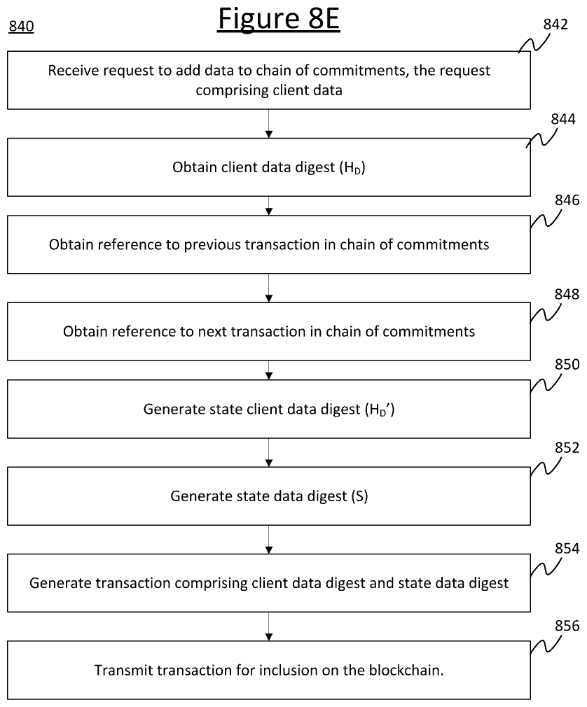

Referring to FIG. 8A, a preferable example “generic case” transaction is shown which comprises both the Data Digest (H_{D}) and State Digest (S) (as discussed under their respective headings below). Preferably, the transaction generated in step 526 as described with reference to FIG. 5B is of this form. This general case transaction is of a known size (and so too are the specific cases). This is because all of the transaction components are of a known and constant size. For example, the transaction input is selected to be of a specific design and size with a known and unchanging scriptSig and therefore unchanging scriptSigLen. Similarly, the output comprises two op codes of a known size and two hashes which have a known and constant size (32 bytes in the present example), irrelevant of the data they are based on. The total size of this generalised transaction design can be summarised according to the following table. Of note, this is the general form a Bitcoin and/or Bitcoin Satoshi Vision (BSV) transaction and is provided as an example only (the general transaction layout also being described here: wiki.bitcoinsv.io/index.php/Bitcoin_Transactions). Other blockchains may have different forms. A skilled person will appreciate the exact values and size thereof may be different for different blockchains and that known sizes can be calculated for different blockchain transactions also.

| Field | Content | Size (bytes) |
|---|---|---|
| Version | — | 4 |
| In_Count | 1 | 1 |
| TxIn | | |
| Outpoint | — | 36 |
| scriptSigLen | 148 | 1 |
| scriptSig | <Sig> <P> | 148 |
| sequence | — | 4 |
| Out_Count | 1 | 1 |
| TxOut | | |
| Value | — | 8 |
| scriptPubKeyLen | 66 | 1 |
| scriptPubKey | OP_0 OP_RETURN <H_{D}> <Sₙ> | 66 |
| Locktime | — | 4 |

| | |
|---|---|
| Total: | 274 |

A skilled person will appreciate that this is the table of a preferred transaction. If, in a different example embodiment, the data digest is not present on the output, then the scriptPubKey will be of the form OP_0 OP_RETURN <Sₙ> and have a size of 34 instead.

With a known transaction size, the funding input can be calculated precisely and the UTXO to fund it can be generated in advance. Thus, a funding service configured to fund the transactions in the chain of commitments, can generate a bank of UTXOs of precisely enough satoshis to pay for the 274 bytes of the transaction to be included in the blockchain.

For the sake of illustration, where the other blockchain is an account-based blockchain such as Ethereum, the same or similar data can also be stored on a transaction for example through use of the optional “data” field which allows for arbitrary data to be associated with or attached to the transaction. More specifically, the “data” field on an Ethereum transaction comprises the State Digest (S) and optionally the Data Digest (H_{D}).

### Data Digest (H_{D})

Optionally, each payload 512a-d comprises a data item which is based on each associated event 506a-d as received from a client and optionally stored off-chain. Preferably, the event data has been received from a client wishing to store a representation of the event on the blockchain for later verification and/or proof of existence of the event. Preferably, the data item based on the associated event is based on a hash of the data associated with each event. Thus, the data item can also be described as a data digest. Preferably, the data digest is salted. More preferably, the event data is hashed twice. Hashing twice advantageously provides a guard against the length-extension property of the hash function. Even more preferably, the event data is hashed twice, then a preimage is generated based on the twice hashed event data and a salt. Preferably the salt is hashed and more preferably hashed twice. The preimage is then hashed. Yet still more preferably, said preimage is hashed twice. Thus, most preferably, the data digest is of the form:

$${H}_{D} := {H}^{2} ( {H}^{2} ( D ) ‖ {H}^{2} ( SALT ) )$$

Where ∥ is a concatenation of the members before and after it and H² is a double hash function.

Hashing is provided is the main example of a one-way function herein. A person skilled in the art will appreciate that other one-way functions may also be used.

Preferably in this embodiment relating to the data digest (H_{D}) as well as throughout the specification, the hashing function used is the SHA-256 cryptographic hash function. “Hashing”, as used throughout the specification, preferably means hashing at least once and more preferably, more than once. Hashing more than once provides resistance to length extension attacks. Alternative to hashing twice (or more), a different hashing function or methodology is used that is not vulnerable to a length extension attack. For example SHA-3 and/or HMAC (optionally using the same salt or a different salt as the key) provide such functionality. A further alternative would be to generate a Merkle tree with the leaf items {Event Data, Salt} and the data digest would be the Merkle tree root.

Salting a hash preferably means to use a “salt”, which is any arbitrary data, as part of the input (along with the data being hashed) to the hashing function. Preferably, the salt is concatenated with the other inputs to the hash function. Optionally, the salt is random.

Preferably, a different salt is chosen for each data item being hashed, i.e. each even in the Event Stream. Preferably, the salt is stored for later data verification usage. As discussed below under the “State Digest (S)” heading, the different salt for each data item is preferably used in generation of the state client data digest (H_{D}′). Salting a hash provides resistance to precomputed “rainbow table” based attacks thereby providing increased security for a client wishing to store potentially sensitive data on the blockchain.

The data digest (H_{D}) can be seen as a unique fingerprint for an item of client data (that has, in the main example, been submitted to an Event Stream). By storing the data digest (as compared with the client data itself), a client using this system is able to store a proof of existence with a known consistent size (irrelevant of the size of the client data) on the blockchain without showing what the contents of the client data.

### State Digest (S)

As mentioned above, the payloads 512a-d comprise or are based on a reference to a previous and a next transaction in the series associated with an event. By providing data that is at least based on the previous and next transactions as described herein in combination with the immutability of the blockchain, secure, unmalleable, and unforkable links between successive parent-child transactions are formed. Here, “unforkable” refers to the property that for a given transaction there can only be one (or zero) next and one (or zero) previous transactions in the set. There is no possibility for the chain of commitments to have more than one possible next or previous transactions and/or events represented by transactions in the set of transactions.

Preferably, a payload 512 comprises state data that is based on a component of a previous transaction and a component of a next transaction. Preferably, these components function as references and are called references. Where previous transaction refers to the transaction generated (and optionally submitted) immediately in time previous to the current transaction being generated and next transaction refers to the transaction to be generated and submitted immediately in time after the current transaction is being generated. Of note, the next transaction may not be generated yet and much of the contents of the next transaction are unknown (as it is impossible to look into the future about what a client might be submitting to be stored on a blockchain transaction). Optionally, the state data is also based on the client data being represented on the blockchain. Optionally the state data is based on a digest of client data which is called the data digest (H_{D}) as described above. Optionally, the state data is also based on metadata about the event and/or metadata about the event stream.

### State Data Structure

As discussed herein, the state data is based on a number of features. Where “based on” is used herein in relation to the state data, preferably this refers to the state data being based on a hash of all of the previous transaction reference, the next transaction reference, and the client data. More preferably the state data is a digest and is alternatively called a state digest. Even more preferably, the state digest is a Merkle tree root where the leaves of the Merkle tree are based on the previous transaction reference, the next transaction reference, and the client data.

In a preferable embodiment, the Merkle tree is based on the previous transaction reference, the next transaction reference, and a state client data digest (H_{D}′). The state client data digest is based on the data digest (H_{D}) and optionally any metadata associated with the event and/or event stream. The state client data digest is described in more detail below under the heading “State Client Data Digest (H_{D}′)”.

Thus, the state digest (S) can be described (with the example previous transaction reference, state client data digest (H_{D}′), and next transaction reference) according to the following formula:

$$S := Merklize ( \{ PREV , {H}_{D}^{′} , NEXT \} )$$

Where the “Merklize” function generates a Merkle root from an ordered set of data elements as leaves, and where {PREV, H_{D}′,NEXT} is an ordered set of leaves based on the elements. Each of the leaves are initially double hashed in the Merklize function. Of note, because of how hashing and Merkle trees work, the order of the set of inputs to it matters, thus the order of the inputs must be the same whenever a Merkle tree is created, recreated, or verified so that the same tree (and therefore same state digest) is generated for the same input data.

Optionally, the state digest is based on a version number. If a version number is specified to the call to the Merklize function as set out below then each leaf node is based on the version number. Preferably, each leaf node preimage is prepended with the version number. Alternatively, each leaf node preimage is postpended with the version number. Preferably, the exact order of version number with leaf node preimage is not important as long as it is consistent between generation and later usage. Advantageously, the use of a version number allows the state digest to be bound to a particular version (as different version numbers will different result in different Merkle tree roots, even if the same input data is used). Preferably, the use of a change in version number is used in coordination with any changes to the specification of now the Merkle tree is constructed (new and/or different leaf nodes for example). Preferably, each version number is tied to a unique specification for the Merkle tree generated.

The Merklize function optionally takes in a version number (v) as a further argument according to the following formula:

$$S := Merklize ( \{ PREV , {H}_{D}^{′} , NEXT \} , v )$$

The Merklize function is preferably the following:

Merklize({PREV, H′_{D}, NEXT}, v):

| 1. | If v == null: | |
|---|---|---|
| | 1.1. | Generate Merkle tree T as: T + GenMerkleTree ({PREV, H5, NEXT}) |
| | 1.2. | Obtain the root R_{T} of the tree T. |
| | 1.3. | Return R_{T} |
| 2. | Else: | |
| | 2.1. | Update each leaf in the list of leaves by prepending the version number: |
| | | 2.1.1. PREV ← v\|\|PREV |
| | | 2.1.2. H′_{D} ← v\|\|H′_{D} |
| | | 2.1.3. NEXT ← v\|\|NEXT |
| | 2.2. | Generate Merkle tree T using updated leaf set: T ← |
| | | GenMerkleTree ({PREV, H′_{D}, NEXT}) |
| | 2.3. | Obtain the root R_{T} of the tree T. |
| | 2.4. | Return R_{T} |

The function GenMerkleTree is preferably taken to mean the standard method for generating a Merkle tree given a set of leaf data items. Preferably, the first step in GenMerkleTree is to hash each of the items in the leaf set ({PREV, H_{D}′, NEXT} in the present example) and more preferably hash them twice.

Referring to FIG. 6, an example generated Merkle tree 600 is shown with the leaf nodes PREV 602, H_{D}′ 604, and NEXT 606. The Merkle tree root 608 is the state digest (S) and preferably is the value that is used on the transaction. This example Merkle tree is constructed as a binary tree where each node has two children (except for the leaves). As there are an odd number of input data items (and thus odd number of leaves), the last unpaired leaf node is doubled. A person skilled in the art will appreciate that the strict adherence to this presented form of the Merkle tree is not necessary and there are other forms that may also work. As discussed above, each item of the input set is hashed twice 610 and each twice-hashed item is used as a leaf of the Merkle tree.

Alternative to the Merkle tree structure, the state digest can be generated by hashing a preimage where the preimage is constructed by concatenating the objects the state data is based on. Thus, in an example where the state digest is based on the previous transaction reference, the state client data digest, and the next transaction reference, a formula could be of the form:

$$S := H ( PREV ‖ {H}_{D}^{′} ‖ NEXT )$$

Optionally, a salt may be incorporated to the preimage also. For example, the salt may be concatenated at the beginning or the end of the preimage.

As a further alternative to the Merkle tree root, the state digest can be generated by using a hash chain. A hash chain is constructed such that each intermediate hash result is prepended with an item the state digest is based on. For example, where the state digest is based on the previous transaction reference, the state client data digest (H_{D}′), and the next transaction reference, a formula could be of the form:

$$S := H ( PREV ‖ H ( {H}_{D}^{′} ‖ H ( NEXT ) ) )$$

Optionally, a salt is incorporated into the hash chain. Optionally, the salt is incorporated by prepending the salt to each intermediate preimage.

### Previous Transaction Reference (PREV)

As discussed above, the state digest is preferably based on a reference to a previous transaction. Preferably, the reference to the previous transaction in the chain of commitments is based on the state data of said previous transaction being referenced. More preferably, the reference to the previous transaction is the state data of said previous transaction being referenced as it is stored on the blockchain. The previous transaction reference is optionally called a parent transaction reference and the current transaction is its child.

Where there is no previous transaction to be referenced (i.e. it is the first in the chain of commitments), the previous transaction reference can be considered a null reference. Preferably, the null reference is a string of zeros. Preferably, the size of the string of zeros is the same size as that of the previous transaction reference were it to be not null. More preferably, the string is 32 bytes long. The table below described a preferred embodiment of the previous transaction reference.

| Option | Name | Description |
|---|---|---|
| S_{Prev} | Prev. state | the state digest included in the previous |
| | digest | Tx to which this Tx is a linked child |
| [0x00; 32] | Null parent | the 32-byte string indicating no |
| | or previous | parent or previous Tx exists |

Optionally or alternatively, the PREV preimage is a JSON structure and/or can be represented using a JSON structure. The JSON structure comprises the above mentioned data options. Advantageously, use of a JSON object provides the ability for, if more data elements were to be added, they may be added and referenced easily.

### Next Transaction Reference (NEXT)

As discussed above, the state digest is preferably based on a reference to a next transaction. Preferably, the reference to the next transaction in the chain of commitments is based on an input to the next transaction. Advantageously, while many of the components of the next transaction is not known (as a result of its existence being in the future and the data submitted by a client) and therefore said unknown components cannot be used as a reference, the input UTXO or UTXOs used for funding a transaction can be determined in advance and will be unique to only that transaction when it is committed to the blockchain. Preferably, the input UTXO(s) are referenced by an outpoint. An outpoint comprises the transaction id of the transaction the UTXO belongs to (called TxID), and the index of the output on said referenced transaction (called vout). The next transaction reference is optionally called a child transaction reference and the current transaction is the parent.

While UTXO-based blockchains (such as Bitcoin) are used as the main illustrative example throughout, a person skilled in the art will appreciate that the present invention can also work on other blockchains. For example, where the blockchain uses an account-based model (such as Ethereum), a transaction can be referenced based on the sender's account address and nonce. Of note, both the senders account address and nonce can be determined in advance of the transaction being generated and/or submitted to the blockchain and further, the pair of senders account address and nonce are unique. These two properties enable the pair to function as a future reference similar to the UTXO based outpoint reference (O_{NEXT}) described herein.

Similar to the previous transaction reference, if there is no next transaction to be referenced (i.e. the current transaction is last in the chain of commitments), the next transaction reference can be considered a null reference. Preferably, the null reference is a string of zeros. Preferably, the size of the string of zeros is the same size as that of the next transaction reference were it to be not null (i.e. the size of a transaction outpoint). More preferably, the string is 32 bytes long. The table below describes a preferred embodiment of the next transaction reference.

| Option | | Name | Description |
|---|---|---|---|
| O_{NEXT} | | Next outpoint | the outpoint of a reserved |
| | | | UTXO for a child Tx |
| | TxID_{NEXT} | Next outpoint | the TxID of the reserved outpoint |
| | | TxID | |
| | υout_{NEXT} | Next outpoint | the output index of the reserved |

| | | |
|---|---|---|
| | index | outpoint |
| [0x00; 32] | Null child | the 32-byte string indicating no |
| | | child Tx is possible |

Optionally or alternatively, the NEXT preimage is a JSON structure and/or can be represented as a JSON structure. The JSON structure comprises the above mentioned data options. Advantageously, use of a JSON object provides the ability for, if more data elements were to be added, they may be added and referenced easily.

### State Client Data Digest (H_{D}′)

As discussed above, the state digest is preferably based on client data, and more preferably a hash of the client data. Even more preferably, the state digest is based on metadata of the event and/or event stream the current transaction relates to.

The table below describes preferred content the state client data digest (H_{D}′) is based on.

| Element | Name | Description |
|---|---|---|
| H_{D} | Data | the data digest for the customer data D |
| | digest | associated with this Tx |
| SALT | Salt | the salt used to mask D, the same or similar |
| | | as is described under the heading “Data Digest” |
| M₁, M₂, . . . | Metadata | an arbitrary number of metadata elements |
| | elements | relevant to this Tx. The number of elements |
| | | will depend on the content being stored. |
| υ | Protocol | a version number indicating the version of |
| | version | the chain of commitments protocol being used. |
| | number | |

Preferably, the data digest H_{D} is defined and generated the same as above under the heading “Data Digest (H_{D})” preferably using the same salting and double hashing methods.

If there are a number of metadata elements, they are enumerated M₁, M₂, etc.

Example metadata elements may include any one or more of the following:
whenRecorded—the time when the event was received from the client and/or stored in the off-chain log,
appVersion—a version number of the chain of commitments,
seed—a seed value used at the start of the generation of the event stream,
delWritelV—an initial value used in the generation of delegated authorisation tokens for writing to the event stream,
delWriteHO—a final hash value used in the validation of delegated authorisation tokens for writing to the event stream,
timeAC—a start and/or end time where the event stream is considered open for writing,
de/Auth/ndex—an index of the delegated token a client used to submit the event,
TxIDcreate—the transaction ID of the first transaction in the chain of commitments, and/or
index—the index of the current event in the Event Stream (not necessarily the same as the index in the chain of commitments as it is not necessary that all events are recorded on the chain of commitments)
nextHashSalt—a hash of the salt as used in the next event. Preferably, the salt is pre-generated for the next event in the chain of commitments, this salt is hashed and is used in the generation of the State Client Data Digest Merkle tree A person skilled in the art will appreciate that other metadata elements may also be used.

Referring to FIG. 7, an example Merkle tree 700 is shown where the root is the state client data digest (H_{D}′) 604 (and is preferably used in the state data Merkle tree 600 as described above with reference to FIG. 6).

Preferably, the set of leaf nodes 706, 708, 710, 712, 714 are arranged such that the data (H_{D}) digest and the metadata leaf nodes are interleaved with the salt. This interleaving enhances the security of the data in the Merkle tree by making it prohibitively expensive for a third party to brute force the Merkle tree. Were a third party to obtain a protocol description for the chain of commitments, and given that H_{D} (the data digest) is preferably stored publicly on the transaction, a third party could brute-force values for M₁, . . . , Mₘ given that these metadata values may be predictable or easily enumerable in many cases (for example, if one of the metadata elements is a timestamp, this may be guessable given the time the transaction was submitted to a blockchain, or one of the metadata elements could be a monotonically increasing index, this may be guessable from a previous state). If the third party is able to brute force these values and correctly reconstruct the value H_{D}′ (i.e. the root of the tree) then they would have successfully confirmed their knowledge of metadata values M₁, . . . , Mₘ. In some cases, these metadata may be sensitive, for example the whenRecorded or writeAccessControl.region properties are used as metadata in EventStream transactions and may be of importance to a malicious third party.

Preferably, the preimage the leaf nodes are based on are prepended with the protocol version number.

Thus, the process of creating the example Merkle tree 700 can be written as the following:

```
DataDigestCommit(H_{D}, SALT, M₁, ... , Mₘ, v):
  1. Generate m-copies of SALT
  2. Order the data items as {H_{D}, SALT, M₁, SALT, ... , Mₘ, SALT}
  3. Generate H′_{D} ← Merklize({H_{D}, SALT, M₁, SALT, ... , Mₘ,
    SALT}, v)
  4. Return H′_{D}
```

Of note, the same Merklize function is used here as with the creation of the state digest as discussed above. As the same Merklize function is used, the preimage for the leaf nodes are similarly optionally twice hashed.

Similar to the discussion of Merkle tree generation above, a number of alternatives to a Merkle tree are possible including concatenating the inputs and hashing the result as well as generating a hash chain.

For the generation of the state client data digest H_{D}′, a protocol version number is preferably used (as compared with the state digest (S) discussed above which preferably provides v=null). As the state digest (S) depends on the state client data digest (H_{D}′), by making H_{D}′ dependent on the protocol version number (v), S does also end up depending on v (even if not directly used in its generation). Here “dependent” means that, if the same inputs were used except for the different protocol version number used in the generation of H_{D}′, S would be different. This thereby enables S to be dependent on the protocol version number without the protocol version number being used twice in the generation of two Merkle trees.

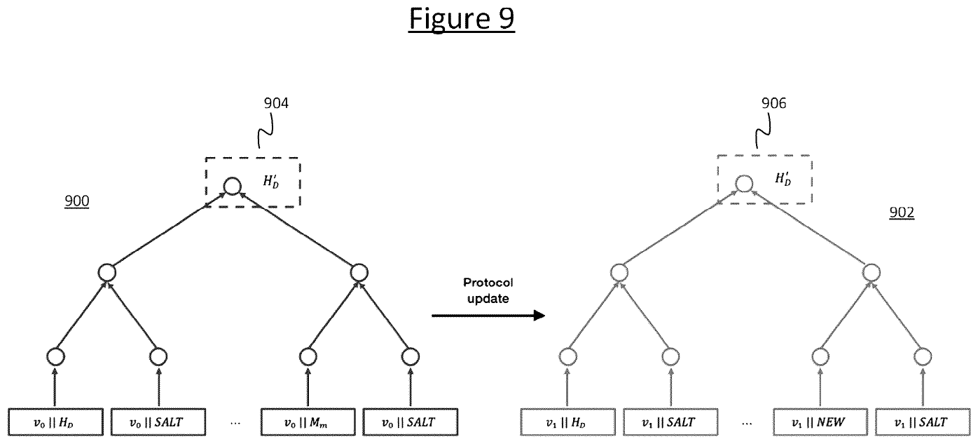

Referring to FIG. 9, two different state client data Merkle trees 900, 902 are shown. The first state client data Merkle tree 900 comprises a Merkle tree root 904 (which is the state client data digest as used in the state digest 608) which is based on a number of leaf nodes and intermediate nodes. The first Merkle tree is generated with a protocol version v₀. As discussed above, the preimage all of the leaf nodes are prepended with the protocol version number. The second Merkle tree is similarly constructed, but with a new unique specification, with a prepended version number v₁. The second Merkle tree also comprises a new (as compared with version v₀) leaf node “NEW”. Thus, any Merkle proof used to prove that an item of data was used in creating H_{D}′ 904, 906 will also prove which protocol version was used to generate the chain of commitments transaction containing the data payload, Note that this will require knowledge of the value of v when both generating and verifying such a proof.

Optionally, the Merkle tree as used in the generation of the client state data digest (H_{D}′), is represented using a JSON structure and/or vice-versa. This is possible due to the hierarchical nature of a JSON structure and a Merkle tree. Here, each element of the JSON structure is a leaf node of the corresponding Merkle tree. Each element will have an associated value that can be hashed—this hashed value is the leaf node in the corresponding Merkle tree. Where a JSON element has child elements (i.e. the value comprises further key-value pairs), that JSON element has a further Merkle tree associated with it. An example alternative JSON object has three top level elements:
hashedData—H_{D} the hash of a blob of data associated with this dataset
hashedNextsalt—the hash of the raw salt to be used by the next chained dataset
metadata—data specific to this dataset item, which can take different forms depending on use case.

Each JSON element is referenced according to its path. An example JSON may look like:

```
{
  “hashedData”: “w6uP8Tcg6K2QR905Rms8iXTlksL6OD1KOWBxTK7wxPI=”,
  “metadata”: {
    “appVersion”: “v1.0.4.30”,
    “esId”:
“eyJsIjoiZnJhbmtmdXJ0IiwibyI6IjAzNzQ3NjNmMTE5YzQ2OGQ5ODY1ZjQ1NGY5ODQ
xMDFiIiwicyI6IkVTIiwidiI6IjEifQ”,
    “index”: 42,
    “sequenceNumber”: false,
    “delegatedAuthIndex”: 0,
    “delegatedAuth”: null,
    “tags”: [
      “foo”,
      “bar”
    ],
    “whenReceived”: “2022-02-13T13:23:52Z”
  },
  “hashedNextSalt”: “oYGilj+52yoDqdrpGYnBgPLn3FmSdaST2evGeogQMs4=”
}
```

As metadata is a JSON element which comprises child elements, the child elements of metadata are used in generation of a further subordinate Merkle tree, the leaf nodes of which are based on the child elements of metadata (i.e. appVersion, esId, etc). The same is also true for the tags element as it too has subordinate elements.

The path of an element is a dot separated string built from the names of the nodes (the names are also described as keys) traversed to reach the element. Elements within an array are denoted by [ ] and their zero-based index within the array. Thus, it can be seen that a number of metadata elements are referenced according to the following paths:

• hashedData - (H_{D} as used herein)
• metadata.index
• metadata.tags [1]

### Example Embodiments

Referring to FIG. 8A, a specific example transaction 800 is shown comprising the data digest (H_{D}) and state data (S) as discussed above. The transaction is the nth transaction in the chain of transactions being stored on the blockchain. The transaction comprises the transaction id TxIDn 802. The transaction comprises a payload 804 stored on a transaction output with op codes (as discussed above) such that the output is unspendable and capable of storing data. Preferably, the two opcodes OP_0 and OP_RETURN are used. The transaction TxIDn is funded by “Fund in” input 818 which comprises a transaction outpoint to identify the transaction that funds it.

The payload 804 also comprises the data digest H_{Dn} and a state digest (S) Sn 810. In the present embodiment, the state digest (S) is a Merkle tree root where the Merkle tree is based on (as signified by the “M” function) all of the previous transaction reference, the client data, and the next transaction reference.

Referring to FIG. 8B, three example transactions 806a, 802, 808a of a chain of commitments 820 is shown. As with FIG. 8A, the transaction TxIDn 802 comprises a funding in 818 and a data payload 804a, where the data payload comprises the data digest (H_{Dn}) and state digest (Sn) 810a and the state digest is a Merkle tree root of a tree based on a reference 812a to the previous transaction 806a, state client data digest 816a, and a reference 814a to the next transaction 808a. It can be seen that the state client data digest 816a is a Merkle tree root of a Merkle tree based on the data digest (H_{Dn}), a salt (SALT), the TxID of the first transaction in the chain of commitments (TxID_{create}) (this being example metadata of the event, event stream and/or chain of commitments) and other metadata as signified by the ‘ . . . ’.

The reference to the previous transaction 812a is the state digest (S) of the previous transaction 806a. The reference to the next transaction 814a is the outpoint of the funding input to the next transaction 808a.

Referring to FIG. 8C, a first 822 and second transaction 808b of a chain of commitments 830 is shown. The first and second transactions comprise funding inputs 818 and payloads 804b.

The payload of the first transaction comprises a data digest (H_{D}) and a state digest (S) 810b all indexed ‘0’ as they are the first (or zeroth) data digest and state digest of the chain of commitments. The state digest is a Merkle tree root where the Merkle tree is based on a previous transaction reference, a state client data digest 816b, and a next transaction reference 814b. As this is the first transaction, the previous transaction reference is a null reference and comprises 32 bytes of zeros. As with the previous example, the next transaction reference is based on the outpoint funding the next transaction in the chain of commitments. The state client data digest is also a Merkle tree root based on a Merkle tree comprising the data digest (H_{Dn}), a salt (SALT), app version metadata (appVersion) as well as other metadata ( . . . ).

Referring to FIG. 8D, an example last 842 and second to last 806b transaction are shown of a chain of commitments 832. Both transactions comprising a funding input 818 and a payload 804c.

The last transaction's 834 payload 804c comprises a data digest (H_{D}) and a state digest (S) 810c. The state digest is a Merkle tree root where the Merkle tree is based on a previous transaction reference 812b, a state client data digest 816c, and a next transaction reference.

As this is the last transaction, the next transaction reference is a null reference and comprises 32 bytes of zeros. As with the example of FIG. 8B, the previous transaction reference is the previous transaction's 806b state digest. The state client data digest is also a Merkle tree root based on a Merkle tree comprising the data digest (H_{Dn}), a salt (SALT), app version metadata (appVersion) as well as other metadata ( . . . ).

Referring to FIG. 8E, an example method 840 of receiving and storing, through use of the chain of commitment embodiments as described herein, a representation of client data on the blockchain is shown. The example method here is a specific example of the method 520 as described with reference to FIG. 5B. A person skilled in the art will appreciate that the strict adherence to the order of the steps is not necessary. For example, the steps relating to obtaining the previous and next transactions 846, 846 can be done in advance of receiving 842 the client data.

In a first step, a request is received either directly or indirectly from a client. The request comprises data the client is wishing to store a representation of on the blockchain, called client data.

Next, client data digest (H_{D}) is obtained 844. Preferably, the client data digest is obtained as described above under the heading “Data Digest” such that the client data is hashed, salted, and then hashed again and preferably the hashing is a double hash.

Next, the previous and next transactions are obtained 846, 848. For the previous transaction reference, the state digest (S) of the previous transaction in the chain of commitments is obtained. Optionally, this is obtained from the blockchain or alternatively, this is stored in a database off-chain and recalled when necessary. For the next transaction reference, the outpoint for funding the next transaction is obtained. Optionally, this is obtained from a funding service which manages the generation and storage of UTXOs for funding. Optionally, the funding service is the same service that is generating the chain of commitment transactions.

With the client data digest (H_{D}) obtained, the state client data digest (H_{D}′) is obtained. Preferably, the state client data digest (H_{D}′) is obtained as described above under the heading “State Client Data Digest” such that a Merkle tree is constructed based on the client data digest, a salt, a protocol version number, and other metadata. The state client data digest H_{D}′ is the root of said Merkle tree.

With all of the state client data digest (H_{D}′), next transaction reference and previous transaction reference, the state digest (S) for the present transaction is generated 850. Preferably, the state digest (S) is generated by constructing a Merkle tree based on the client data digest, next transaction reference and previous transaction reference. The root of said Merkle tree is the state digest (S).

A transaction is generated 854 with an output comprising the client data digest (H_{D}) and the state digest (S).

The transaction is transmitted to a blockchain node for inclusion on the blockchain.

### Rendezvous Transactions

It may also be desired to generate a transaction which exists across a plurality of different chains of commitments. Such a transaction that exists across multiple different chains of commitments is called a “rendezvous transaction”. Rendezvous transactions provides a way to atomically synchronise multiple chain of commitments. This may be of relevance if a single event is related to a number chains of commitments (or the Event Streams they represent) and the event needs to be recorded atomically across the different chains.

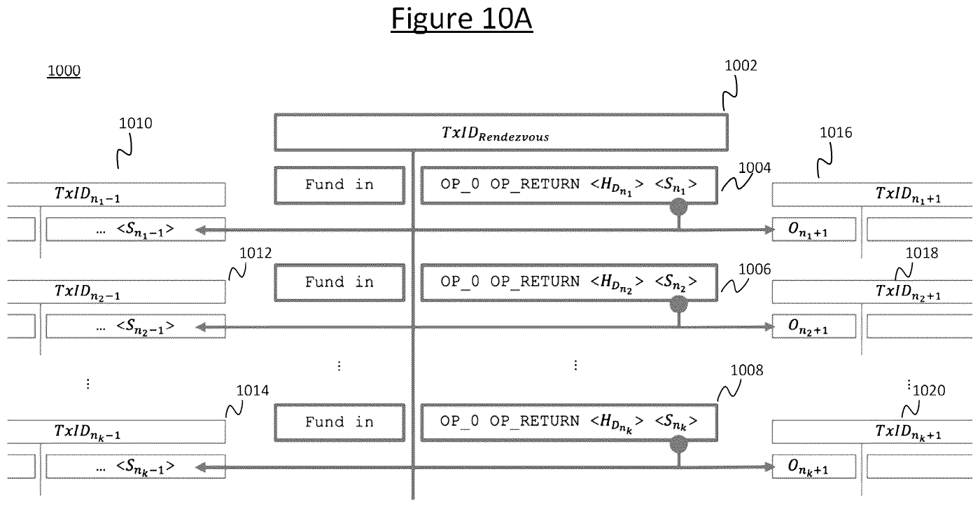

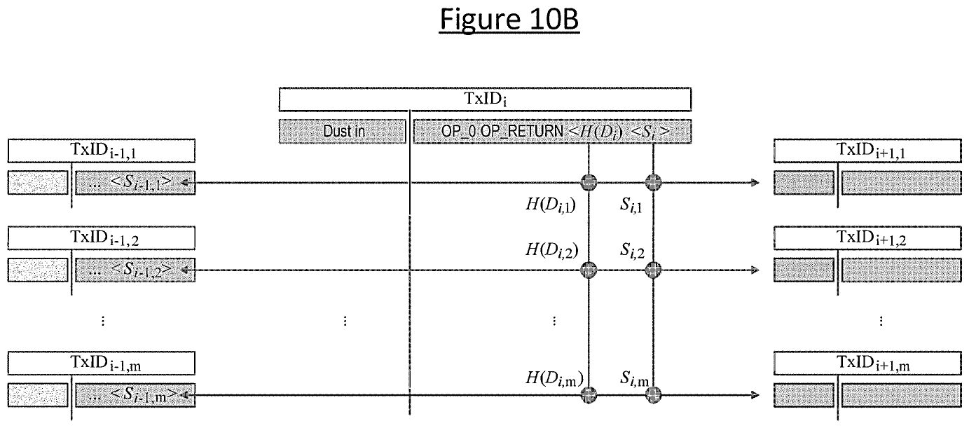

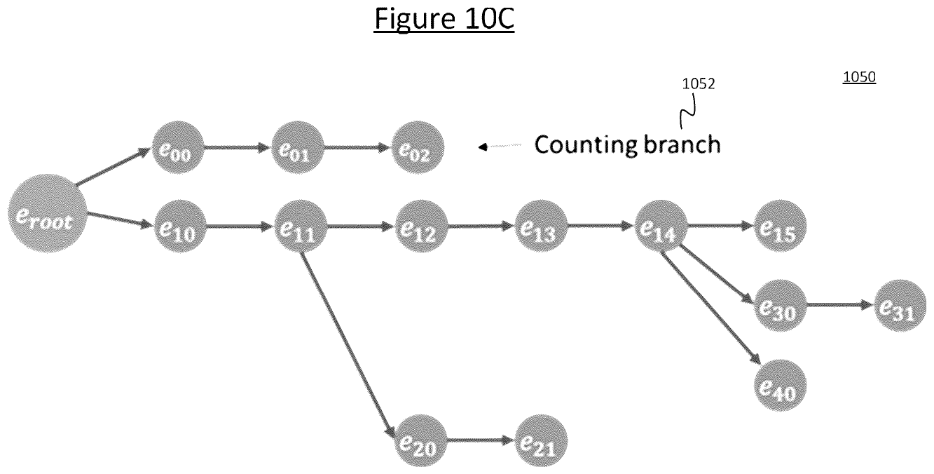

Referring to FIG. 10A, an example Rendezvous transaction 1002 is shown as a part of multiple chains of commitments 1000. It can be seen that one output 1004, 1006, 1008 is used per chain of commitments the Rendezvous transaction is a part of. For example, if the Rendezvous transaction is a part of three chain of commitments, the Rendezvous transaction comprises three outputs. Each transaction output comprises a payload that relates to a respective chain of commitments.

Preferably each output 1004, 1006, 1008 of the rendezvous transaction is of the same form as described above with reference to a non-rendezvous chain of commitments transaction in that the output comprises a data digest and a state digest (S) (the state digest being based on a reference to the previous and next transactions in the chain, as well as a state client data).

Each output 1004, 1006, 1008 of the rendezvous transaction also has a corresponding funding input. Optionally, this funding input is of the same form and amount as with a non-rendezvous chain of commitments transaction. Advantageously, by using the same UTXO fund input referencing method, a non-rendezvous transaction can still reference a rendezvous transaction in the next transaction reference without any further modification (as the rendezvous transaction will still have a funding input to reference). Similarly, the rendezvous transaction still comprises a state digest (S) on each output such that a next transaction in the chain of commitments referencing a rendezvous transaction can still use the same preferred previous transaction reference.

Thus, as can be seen in the figure, each rendezvous transaction output 1004, 1006, 1008 is based on a reference to its corresponding previous non-rendezvous transaction 1010, 1012, 1014 through use of the state digest (Sₙ₁₋₁, Sₙ₂₋₁, Sₙₖ₋₁). Also it can be seen that each rendezvous transaction output is based on a reference to its corresponding next non-rendezvous transaction 1016, 1018, 1020 using the funding input reference of the next non-rendezvous transaction reference (Oₙ₁₊₁, Oₙ₂₊₁, Oₙₖ₊₁).

Referring to FIG. 10B, an alternative method of constructing a rendezvous transaction is shown. Here, instead of a different input and output per chain of commitments that TxIDi belongs to (as shown in FIG. 10A), a single transaction input and output is used.

The Data Digest (H_{D}) of TxIDi is instead based on all of the client data D submitted across all of the different chains. Preferably, Data Digest is a Merkle tree root, wherein the Merkle tree is generated each leaf node is based on the client submitted data of each chain. Preferably, a hash of each client data is used. This way, the size of the Data Digest is as stored on the blockchain remains the same irrespective of the number of the chain of commitments the transaction TxIDi is a part of.

Similarly, the State Digest is based on all of the previous transaction references as well as all of the next transaction references. Instead of a Merkle tree comprising only PREV, H_{D}, and NEXT as preimages to the leaf nodes, all of PREV references across the different chain of commitments, all of the HDs across the different chain of commitments, and all of the NEXT references across all of the different chain of commitments are leaf nodes. This provides similar advantages that the single output of TxIDi does not increase in size, even though it is based on a potentially substantially larger amount of data.

Alternative to the Merkle trees as described in the previous two paragraphs, all of the received client data across the different chain of commitments are concatenated and hashed to give a final Data Digest and all of the PREVs, HDs, and NEXTs across all the different chain of commitments are concatenated and hashed to give a final State Digest.

As a further alternative to the Merkle trees described above, all of the received client data, PREV, and NEXT data across all of the chains of transactions are concatenated and hashed. Thus, the State Digest can be determined according to the following expression:

$$S := {H}^{2} ( PREV ‖ {H}_{D}^{′} ‖ NEXT ‖ PREV\_ 1 ‖ {H}_{D}^{′1} ‖ NEXT\_ 1 ‖ PREV\_ 2 ‖ NEXT\_ 2 )$$

Where PREV_1, NEXT_1, PREV_2, NEXT_2 are transaction references of same form or format as described under the headings “Previous Transaction Reference (PREV)” and “Next Transaction Reference (NEXT)”, except referring to different chains of transactions. The presence of the data digests are optional and depend on the nature of the chain of transactions being linked through the rendezvous transaction.

### Multi Branch Chains of Transactions

Turning to FIG. 10C, an example branching chain of transactions data structure 1050 is shown. The example provided in FIG. 10C is for illustrative purposes and a person skilled in the art will appreciate that many different branching layouts are possible. Preferably, the branching data structure makes use of the same transaction layouts as described under the heading “Rendezvous Transactions”. For example, where the transaction e11 refers to both transactions e12 and e20, either the e11 transaction comprises one input and one output for each branch (as set out in FIG. 10A), or the e11 transaction comprises one State Digest which is based on NEXT references to both e12 and e20 (as set out in FIG. 10B).

Of note, the transactions which introduce branches (called branching transactions) e11, e14, eroot, comprise more NEXT references than they do PREV references. A person skilled in the art will appreciate that this can be implemented through use of the NULL PREV reference, use of the same PREV reference for both branches (for example, e10 is used as a PREV reference twice in the e11 branching transaction), and/or the data structure simply does not include the second PREV reference. In the latter example, the presence of a greater number of NEXT references as compared to PREV references can be used to indicate the current transaction is a branching transaction.

Optionally, multi-branch chains of transactions comprise a counting branch 1052. The counting branch is branched from the eroot transaction and is used to count the number of branches the chain of transactions has. Preferably, each transaction on the counting branch e00, e01, e02 comprises data indicative of the number of branches.

To illustrates how the counting branch operates, description is provided in relation to the branching layout as shown in FIG. 10C. A person skilled in the art will appreciate that other branching layouts may be possible. An eroot transaction is generated first with two references: one NEXT reference to e00 which is associated with the counting branch and one NEXT reference to e10 which is associated with another chain of transactions. e00 comprises data capable of attesting that there is only 1 other branch which starts with e10.

At some point later, two events occur such that the chain of transactions needs to be branched at e11. Transaction e01 is generated comprising data capable of attesting that there are now two branches starting from e11. Optionally, the transaction also is based on a reference to the second branch e20. At a point in time later again, an event occurs where two more branches are needed from e14. A transaction e02 is generated comprising data which can be used to attest that the number of branches is now four in total.

To verify a multi branched chain of transactions, the verifier starts with the counting branch to determine how many branches there are and where the branches started. By doing this, the verifier can ensure that each chain of transactions is unique and there are no hidden branches or hidden versions. Thus, the counting branch enhances the security of chain of transactions while still maintaining the privacy/secrecy of the layout and data stored on the blockchain.

### Cross-Chain Blockchain References

As discussed about in the section titled “Next Transaction Reference (NEXT)”, the NEXT reference can be made to any UTXO-based blockchain transaction (through use of outpoints) or to any account-based blockchain transaction (through use of the sender's account address and the nonce). This concept is optionally described as “cross-chain referencing” because a transaction on one blockchain can comprise data which is based on a reference to a transaction on a different blockchain.

Thus, it can be seen that the NEXT reference may point to different blockchains, including ones that do not have transactions of the same format. For example, where the chain of transactions (which could be associated with an event stream) is recorded on a UTXO-based blockchain such as Bitcoin SV, an example transaction, TxIDn can comprise a State Digest which is based on a NEXT reference that is referring to an Ethereum transaction TxIDₙ₊₁ which has not been committed to the Ethereum blockchain yet (and the transaction ID is not knowable yet). As discussed above, the Ethereum transaction reference is based on the sender's account address and a nonce. This way, the chain of transactions can continue on a second (or any further number) of blockchains.

Preferably, the TxIDₙ₊₁ transaction also comprises a State Digest based on a NEXT reference to a further transaction TxIDₙ₊₂ such that the chain of transactions continues (unless the TxIDₙ₊₁ is the result of a finalise event and thus ends the chain of transactions.

Optionally, when a cross-chain reference is used, the NEXT reference comprises a blockchain identifier to indicate which blockchain is being referenced. Preferably the blockchain identifier is in the form of a three-letter identifier, similar to that of an ISO 4217 identifier. The presence of the blockchain identifier can be used to indicate that a cross-chain reference has been used. Alternatively, the blockchain identifier is present in every transaction. Example blockchain identifiers could be BTC for Bitcoin, BSV for Bitcoin SV, ETH for Ethereum, XMR for Monero, etc.

Alternatively, as discussed under the heading “State Data Structure”, the H² hash function can instead be a Merklize function that takes the list of inputs as leaf nodes. We note that the same or similar features regarding salting, ordering, and other features as described under the “State Data Structure” similarly apply to State Digest data structures that comprise more than 2 transaction references.

Advantageously, cross-chain referencing provides greater flexibility to the user creating the chain of transactions (and/or the owner of an associated event stream).

Further advantageously, cross-chain referencing provides the ability for the chain of transactions to take advantage of a different blockchain's technical features. For example, if a different blockchain implemented an advantageous transaction type and/or improved security features, then the cross-chain reference ensures that the chain of transactions remains securely linked even when moving to said different blockchain. Similarly, if a currently used blockchain was forked and the ability to store data in an OP_RETURN op code was to be removed, then cross-chain referencing can be used to maintain the secure linking of the chain of transactions across to a different blockchain that does allow appropriate data storage (like Ethereum's “data” field or BSV's OP_RETURN).

Further advantageously, cross-chain referencing provides the ability for the chain of transactions to take advantage of lower transaction fees on a different blockchain, even if temporarily.

Further advantageously, cross-chain referencing provides the ability to reference transactions which may only be able to be attested or referenced on a particular blockchain. For example, if an event associated with an Ethereum smart contract needs to be included and/or securely reference in a current chain of transactions, then a reference to the appropriate smart contract transaction can be made.

A person skilled in the art will appreciate that the Cross-Chain Blockchain References can also be used with Rendezvous Transactions and/or Multi Branch Chains as described here such that it is possible to branch a chain of transactions to a different blockchain and/or atomically associate an event occurring on two chains of transactions which use different blockchains.

### Blockchain Data Submission Frequency

As described herein, an example is used where all client data received is for commitment to the blockchain. Alternatively, however, there is provided different options where only a subset of the received data is transmitted to the blockchain.

As described herein, at least two datasets are used: an off-chain storage and an on-chain storage (as discussed with reference to FIG. 5A). The on-chain storage comprises a subset of the off-chain dataset (not necessarily a strict subset though). There are three different methods a client can select to vary the number of times events are reflected in the blockchain: onFinalise, checkpoint, and onEvent.

For the onFinalise method, no transactions are submitted to the blockchain except for the create transaction and a finalise transaction. Thus, the trigger condition for the onFinalise method is reception of a message to end the stream. Thus, the on-chain dataset comprises only two items.

In situations where events in the event stream should not be made public (such as in a voting system extending over only a short period of time), the onFinalise method may be used. The onFinalise method will not store any event related data on the blockchain other than create and finalise transactions. Once concluded, the final transaction can comprise metadata or statistics about the vote (such as total number). A final streamDigest in the finalise transaction, as discussed above, can be used to verify that the whole chain has not been tampered with.

For the onEvent method, every event that is added to the off-chain database will also have data representative of it on the blockchain. For onEvent, the trigger condition is upon reception of an event. Thus, every time an event is received or created, or any time the event stream is updated, the platform processor is triggered to add the event to the blockchain. The platform processor generates the appropriate data to add to the blockchain.

Where the presence of an event occurring and/or the actual content of the event is relevant to the public, the onEvent method may be used. An example usage of this method is an honest tender process. In this example case, it is in the public interest to know that tenders have been submitted and by who. The presence of the events in the public blockchain achieves this purpose.

For the checkpoint method, two example embodiment trigger conditions are provided. The first being time based and the second being based on the number of events received (not dissimilar from the onEvent method, except instead of it being every event, it's every nth event). The on-chain dataset in this embodiment comprises at least some (or optionally all) of the items in the off-chain dataset.

Further to the above, a reduction in the size of the transaction and submitting data to the blockchain less often, e.g. on checkpoint or onFinalise results in a reduction in the associated carbon footprint of said transaction sets. A larger number of transactions results in greater processing required. Where a Proof-of-Work consensus mechanism is used (such as Bitcoin and its derivatives), this energy saving is particularly relevant as said consensus mechanism is a computing intensive and therefore energy intensive process that can result in a large carbon footprint.

In cases where an event is triggered whenever a transaction is submitted to the blockchain, an endless loop can occur if using the onEvent method (and/or when the checkpoint method is configured to make the threshold 0 or 1, which results in the same or similar data being submitted to the blockchain as the onEvent method). The endless loop will result because when the first transaction is submitted (no matter what causes it), the onEvent mechanism triggers a further transaction to be submitted to the blockchain, which in turn triggers a yet another event to be submitted to the blockchain, ad infinitum. This problem can be avoided by using a triggering mechanism as described below. By using either of the triggering mechanisms described below, this problem is solved.

The time-based trigger condition is such that the blockchain event stream is updated at a given time interval. The time interval is set by the client and is a parameter in the create message. Preferably, the time interval is constant and does not change through the lifetime of the event stream.

The timer-based trigger condition is optionally implemented using a language level timer, for example a Java Timer and TimerTask. Continuing with the Java example, a create message is received that comprises an indication that a timer based trigger condition is to be used and a specific time to wait between event submissions to the blockchain is also present (every minute for example). A Timer is established to trigger at a period according to the specific time to wait between event submissions. A TimerTask is also established to obtain the current event stream state and arrange for that current event stream state to be submitted to the blockchain. Every time the Timer triggers, the TimerTask is run. Example pseudo Java code may look like:

```
final long period = 1000L * 60L; // 1 minute, from create message
public void updateBlockchain_timerBasedTrigger( ) {
  TimerTask repeatedTask = new TimerTask( ) {
    public void run( ) {
      // obtain data indicative of a state of the stream
      // generate a transaction comprising said data
      // broadcast the transaction to the blockchain
    };
  }
  Timer timer = new Timer(“Event Stream Update”);
  timer.scheduleAtFixedRate(repeatedTask, new Date( ) , period);
}
```

Alternatively, an operating system level scheduler is used such as cron. An example crontab setting to run every 5 minutes could look like:
*/5* * * * /usr/bin/java MyClass.TimerTask( )

A person skilled in the art will appreciate that there are further ways to establish timer-based execution beyond the two examples provided here. These are provided as examples only for a skilled person to understand a possible way to implement timer-based triggering.

As an alternative, or in addition to the above timer-based trigger condition, a trigger condition based on the number of events received is used. A given number of events is set in the create message (for example 10). This given number is considered the threshold number of events to trigger updating to the blockchain. Every time an event is received, the total number of events received since the previous on-chain stream update (or since the create message was received if no on-chain stream updates have been made yet) is compared with the threshold number of events. Based on that comparison, the on-chain dataset is updated. The comparison is preferably based on whether the number of events received is equal to or greater than the threshold number of events. Example pseudo Java code may look like below (where numberOfEventsBasedTrigger is called every time an event is received or event stream is otherwise updated):

```
final int thresholdEventReceived = 10; // from create message
static int numberEventsReceived = 0;
public void numberOfEventsBasedTrigger( ) {
  Task repeatedTask = new Task( ) {
    public void run( ) {
      // obtain data indicative of a state of the stream
      // generate a transaction comprising said data
      // broadcast the transaction to the blockchain
    };
  };
  numberEventsReceived += 1;
  if (numberEventsReceived >= thresholdEventReceived) {
    repeatedTask.run( );
    numberEventsReceived = 0;
  }
}
```

Preferably only one trigger condition is possible (timer-based or number of events based). Alternatively, both trigger conditions can be used and then each time either of the trigger conditions is met, the on-chain dataset is updated.

The “obtain data indicative of a state of the stream” step in the examples above preferably will be to obtain the latest event and extract or generate the Data Digest (H_{D}) and State Digest (S). The “generate a transaction comprising said data” and “broadcast the transaction” steps preferably comprises sending a message to the message bus for the platform service to submit the transaction to the blockchain asynchronously to the above method and in a different thread, process, or device. Preferably these steps are the same or similar as the generate 526 and submit 528 steps as discussed in FIG. 5B.

If the checkpoint or onFinalise method is used, an optional checkpointNow flag is optionally used. When a new event is received for storage in the off-chain dataset (and potentially in the on-chain dataset if the appropriate trigger condition is met), the checkpointNow flag can optionally be set. If the flag is set, it will force, irrespective of whether any trigger condition has been met or not, data associated with the received event to be stored on the on-chain dataset. The check can be considered an override flag as it overrides the checkpointing method to force data to be added to the on-chain dataset.

Thus, upon reception of an event to add to the event stream, if the flag is set, the event data, or data based upon the event data is added to the on-chain dataset.

Advantageously, this gives more freedom to the client submitting data to the event stream to allow or require that important data or events are committed to the on-chain dataset for auditing. Important events could include passing particular milestones for the event stream such the data being stored resulting in reaching a particular state in an associated finite state machine or smart contract.

Another advantageous use this technical feature could enable would be to allow for a stream to be settled at particular important times that the checkpoint method might not capture. If for example, the checkpoint method is used to add data to the on-chain dataset midday every day, but a client wishes for the current event to be recorded on midnight on the last day of the financial year (for financial reporting purposes), then the client simply adds the checkpointNow flag to the last event they submit before midnight and it will be added to the on-chain dataset for auditors to review irrespective of any previous checkpoint trigger conditions being set.

### Event Stream Platform System

According to a further aspect, any one or more of the preceding aspect's methods and systems may be used with a platform processor as described below for providing the on-chain and off-chain data storage as described in the first aspect and/or verification of on-chain and off-chain data storage in the second aspect. This further aspect may be Platform as a Service (PaaS) and Software as a Service (SaaS) offering that advantageously enables rapid delivery of useful real world business and technical applications, such as management of software controlled technical systems or smart contracts, using a blockchain network such as the BSV blockchain.

An overview of the platform services can be seen in FIG. 11 that shows a high-level schematic of the system. The platform service has a platform processor 1500 that provides an API 1508, via which the services may be accessed by one or more clients.

Platform Services 1500 as shown in this Figure are made up of three families of services and is aimed at allowing users and organisations to easily and securely make use of the advantages offered by the unique properties of a blockchain, without actually implementing any blockchain based software, knowledge, or libraries at the client end. These services are:
Data Services 1502 that aim to simplify the usage of the chain as a commodity data ledger. The Data Services preferably use the data structures and methods provided herein for implementing data writing to and reading from the blockchain.
Compute Services 1504 that aim to provide a generalised compute framework backed by a digital asset such as Bitcoin SV.
Commerce Services 1506 that provide enterprise-class capabilities for transacting using a digital asset such as Bitcoin SV.

Requests may be received via or using the HTTPS protocol from a client at the API, as the API is implemented as a web service. The requested services are then implemented by the one or more service modules or processing resources 1502-1506 using underlying software 1510, such underlying software 1510 being associated with the blockchain, i.e. to implement resources, libraries and/or key-management wallet implementations for creating, processing and submitting transactions associated with the blockchain. Once processed, transactions can be submitted to the blockchain network 1512 (instead of the client implementing any such functionality or transaction libraries). At most, the client may or can implement a digital wallet or the like associated with cryptocurrency or some other digital asset, but this is not essential as the platform service 1500 may also be able to provide and manage the digital asset for the client.

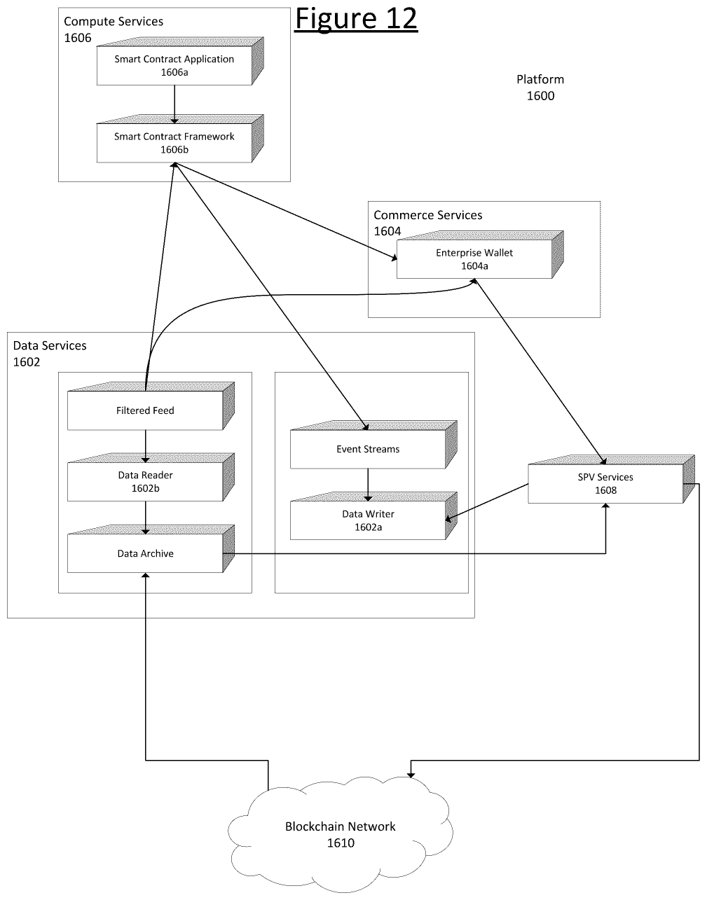

FIG. 12 provides a more granular schematic view of the plurality of services associated with a blockchain, and which can be implemented by the platform 1600 that is associated with an API via which any one or more of the offered services can be accessed. As seen in this FIG. 12, the data services 1602 may include a data writer 1602a and a data reader service 1602b. The event streams and/or data writer optionally implement the method 840 as described in FIG. 8E. Similarly, the client and/or third party wishing to access the data they have written using the embodiments described herein may use the data reader 1602b. Further details of event streams are discussed with reference to FIGS. 4 to 8 of UK Patent Application No. 2002285.1 (filed in the name of nChain Holdings Limited on 19 Feb. 2020) and is hereby incorporated by reference. The data writer service 1602a enables clients to write data into the blockchain in a simple, secure and optimised manner. The data reader service 1602b enables the clients to send queries, which returns data that is stored in the blockchain. This may be using filtered streams in which the client may pre-define the type of data that they wish to read from the blockchain on an ad hoc or periodic basis, i.e. within a certain timeframe, or those associated with a set of related or unrelated events or documents that are processed in the blockchain 1610. The data archive feature allows access to logs of previous transaction for a specified event or contract.

The compute services 1606 of the platform 1600 includes an application 1606a and framework 1606b associated with smart contracts, which in some embodiments may be represented as a state machine in the blockchain 1610. The compute services 1606 interacts with the data services 1602 as data will need to be input and results provided to a client for any such computation.

Commerce services 1604 are responsible for provision of enterprise-class capabilities via enterprise wallets 1604a for transacting over the blockchain 1610, based on best-in-class security practices and technologies. For example, in some embodiments, enterprise wallets may implement functionality to enable blockchain transaction processing when more than one person or user or account may need to sign off on a transaction meeting a defined criterion. i.e. associated with cryptocurrency of a large value above a certain predefined limit.

An enterprise wallet may also include functionality to implement a threshold number and/or type of signatures to move large amounts of digital assets such as cryptocurrency or tokens representing another resource. The movement of these assets can then be represented on the blockchain following processing based on the criteria applied by such enterprise wallet implementation.

The SPV services 1608 (simplified payment verification) are applications that require information from the blockchain but do not include direct links to it, as they do not run a miner node. Such SPV service 1608 allows a lightweight client to verify that a transaction is included in a blockchain, without downloading the entire blockchain 1610.

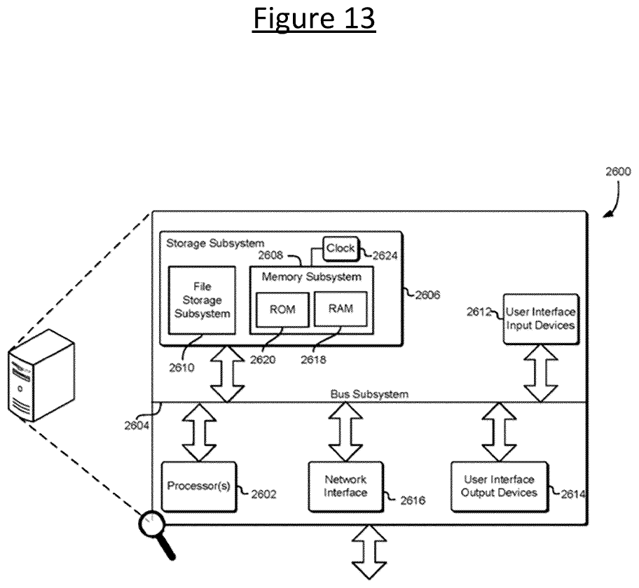

Devices Turning now to FIG. 13, there is provided an illustrative, simplified block diagram of a computing device 2600 that may be used to practice at least one embodiment of the present disclosure. In various embodiments, the computing device 2600 may be used to implement any of the systems or methods illustrated and described above. For example, the computing device 2600 may be configured to be used as one or more components in the systems 1500, 1600 of FIG. 11 or 12, or the computing device 2600 may be configured to be a client entity that is associated with a given user; the client entity making database requests and/or submissions, the platform processor, and/or database manager. As a further example, the computing device 2600 may be configured to undertake the methods 520, 840 of FIGS. 5B and 8E. Further still, the computing device 2600 may be configured to generate the on-chain and off-chain structures 504, 502, 600, 700, 800, 820, 830, 832, 900, 902, 1000, 1050 as described in FIGS. 5, 6, 7, 8A-D, 9, and 10A-B. Thus, computing device 2600 may be a portable computing device, a personal computer, or any electronic computing device. As shown in FIG. 13, the computing device 2600 may include one or more processors with one or more levels of cache memory and a memory controller (collectively labelled 2602) that can be configured to communicate with a storage subsystem 2606 that includes main memory 2608 and persistent storage 2610. The main memory 2608 can include dynamic random-access memory (DRAM) 2618 and read-only memory (ROM) 2620 as shown. The storage subsystem 2606 and the cache memory 2602 and may be used for storage of information, such as details associated with transactions and blocks as described in the present disclosure. The processor(s) 2602 may be utilized to provide the steps or functionality of any embodiment as described in the present disclosure.

The processor(s) 2602 can also communicate with one or more user interface input devices 2612, one or more user interface output devices 2614, and a network interface subsystem 2616.

A bus subsystem 2604 may provide a mechanism for enabling the various components and subsystems of computing device 2600 to communicate with each other as intended. Although the bus subsystem 2604 is shown schematically as a single bus, alternative embodiments of the bus subsystem may utilise multiple buses.

The network interface subsystem 2616 may provide an interface to other computing devices and networks. The network interface subsystem 2616 may serve as an interface for receiving data from, and transmitting data to, other systems from the computing device 2600. For example, the network interface subsystem 2616 may enable a data technician to connect the device to a network such that the data technician may be able to transmit data to the device and receive data from the device while in a remote location, such as a data centre.

The user interface input devices 2612 may include one or more user input devices such as a keyboard; pointing devices such as an integrated mouse, trackball, touchpad, or graphics tablet; a scanner; a barcode scanner; a touch screen incorporated into the display; audio input devices such as voice recognition systems, microphones; and other types of input devices. In general, use of the term “input device” is intended to include all possible types of devices and mechanisms for inputting information to the computing device 2600.

The one or more user interface output devices 2614 may include a display subsystem, a printer, or non-visual displays such as audio output devices, etc. The display subsystem may be a cathode ray tube (CRT), a flat-panel device such as a liquid crystal display (LCD), light emitting diode (LED) display, or a projection or other display device. In general, use of the term “output device” is intended to include all possible types of devices and mechanisms for outputting information from the computing device 2600. The one or more user interface output devices 2614 may be used, for example, to present user interfaces to facilitate user interaction with applications performing processes described and variations therein, when such interaction may be appropriate.

The storage subsystem 2606 may provide a computer-readable storage medium for storing the basic programming and data constructs that may provide the functionality of at least one embodiment of the present disclosure. The applications (programs, code modules, instructions), when executed by one or more processors, may provide the functionality of one or more embodiments of the present disclosure, and may be stored in the storage subsystem 2606. These application modules or instructions may be executed by the one or more processors 2602. The storage subsystem 2606 may additionally provide a repository for storing data used in accordance with the present disclosure. For example, the main memory 2608 and cache memory 2602 can provide volatile storage for program and data. The persistent storage 2610 can provide persistent (non-volatile) storage for program and data and may include flash memory, one or more solid state drives, one or more magnetic hard disk drives, one or more floppy disk drives with associated removable media, one or more optical drives (e.g. CD-ROM or DVD or Blue-Ray) drive with associated removable media, and other like storage media. Such program and data can include programs for carrying out the steps of one or more embodiments as described in the present disclosure as well as data associated with transactions and blocks as described in the present disclosure.

The computing device 2600 may be of various types, including a portable computer device, tablet computer, a workstation, or any other device described below. Additionally, the computing device 2600 may include another device that may be connected to the computing device 2600 through one or more ports (e.g., USB, a headphone jack, Lightning connector, etc.). The device that may be connected to the computing device 2600 may include a plurality of ports configured to accept fibre-optic connectors. Accordingly, this device may be configured to convert optical signals to electrical signals that may be transmitted through the port connecting the device to the computing device 2600 for processing. Due to the ever-changing nature of computers and networks, the description of the computing device 2600 depicted in FIG. 13 is intended only as a specific example for purposes of illustrating the preferred embodiment of the device. Many other configurations having more or fewer components than the system depicted in FIG. 13 are possible.

### Example Illustrative Applications

### Banking Institutions

In the present example, a first Bank A is using Blockchain A and a second Bank B using Blockchain B. Both banks are using event streams (which is using the chain of transaction technology described herein) to capture account activities of their customers for Anti-Money Laundering (AML) compliance, and one event stream for one legal entity/identity. Alice is a customer with one account at each bank.

Through use of cross-chain blockchain references, a single event stream (and thus a single chain of transactions) can be used to track Alice's interactions with both institutions that is able to hop between Blockchain A and Blockchain B. This Alice to keep a unique event stream simplifying her financial management as well as improving the efficiency of auditability (for example for the purposes of AML) as all of her relevant transactions with each bank is stored in a single chain of transactions and an auditor does not need to traverse multiple blockchains, multiple accounts, and multiple event streams.

### Document Signing

In the present example, the goal is to capture document signing as an event in a blockchain transaction. The signer is expected to include the event in a blockchain transaction. The entity who requests the signature (the requester) can prepare an event stream transaction that includes a commitment which specifies a blockchain transaction of the signer's choice. This allows the signer to select whichever blockchain they prefer (if perhaps they do not have cryptocurrency and/or the means to generate transactions on the requester's blockchain). This example shows the flexibility cross chain references can provide to users of event streams and chains of transactions generally.

### Livestock Tracking

An example application of the ordered, append-only data storage as described here with reference to FIGS. 5A to 13 is for use with livestock tracking. To adhere to international livestock market rules and regulations, secure tracking of all of ownership, use, and other management of livestock is needed. In particular, the presence of current animal pathologies and the perceived risk for new emerging pathologies highlights the importance of increased security of livestock management generally. Thus, it can be seen that the use of the ordered, immutable, blockchain based data storage system described herein can advantageously assist anyone involved with the management, sale, purchase, use of livestock to verify that the information associated with any animal they are interacting with is correct and immutable.

Vaccination status and ownership tracking are of particular importance and the use tamper-proof and privacy-preserving record of sequential events (as set out herein) can achieve or assist in achieving secure vaccination status tracking. The sequence in which events happen needs to be maintained to prove the time flow order and dependencies or interference in the events occurrence.

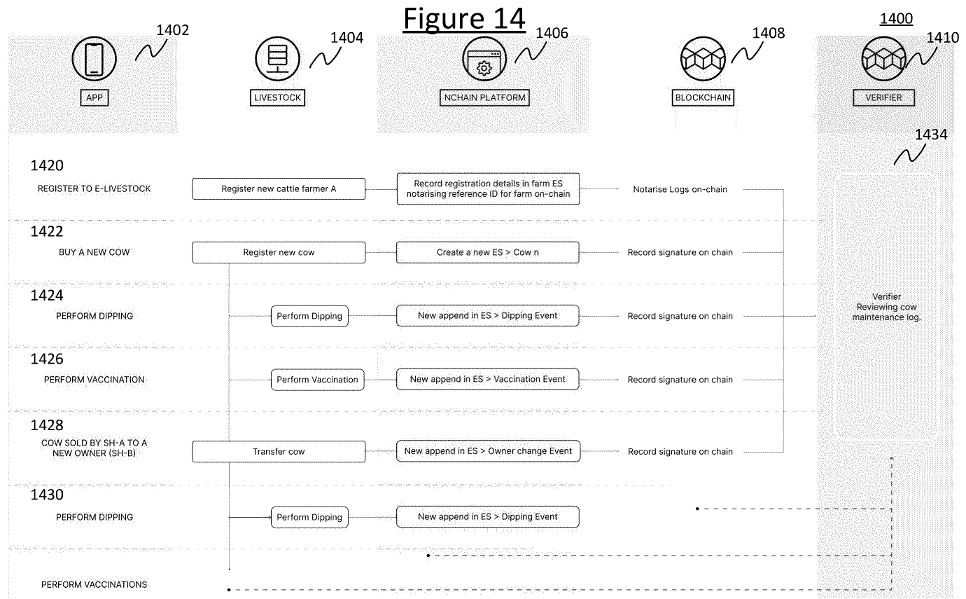

Turning to a specific example of the system, FIG. 14 provides a schematic diagram 1400 of a number of possible data flows and process as conducted by different members in the system. As can be seen here, the process platform member 1408 conducts several Event Stream (ES) blockchain writing based actions 1420, 1422, 1424, 1426, 1428, 1430. Event Streams are provided here as a specific example of an API processing layer of interaction with the blockchain. A person skilled in the art will appreciate that other APIs may be possible which similarly maintains an ordered, append only list of events and store them on the blockchain in accordance with the embodiments described herein. The process platform member can also be described as a blockchain interface system or server. Also shown is a blockchain based verification process 1434 using the blockchain data in coordination any or all of the blockchain 1408, the processing platform 1406 and the livestock database 1404.

The proposed livestock tracking system 1400 comprises a number of hardware elements and software elements. Users of the system have a smartphone with livestock management software application 1402. The application is configured to communicate with a livestock database (or other server) 1404. The livestock database is configured to interact with the process platform 1406, which is referenced in the figure as the nChain platform. The process platform is configured to record attestation data to a blockchain 1408 in accordance with the chain of transactions as described herein.

Each animal has an associated identification tag. The identification tag uniquely identifies each animal among the livestock. The identification tag preferably has a unique identifier associated and/or stored on the tag.

The identification tag is preferably in the form of an RFID (Radio Frequency Identification) tag embedded within the animal. Alternatively, the identification tag is a physical cattle ear tag which has a QR code printed on it, the QR code encoding the unique identifier and the QR code.

Preferably, ultra-high frequency (UHF) RFID are used that have a read range of 1 m to 12 m. UHF-RFID tags are passive, meaning they do not require an additional power source. Passive tags are low-cost and therefore more accessible for farmers.

A livestock database 1404 is provided which comprises all the unique identifiers associated with each animal and preferably stores additional information associated with each animal. For example, the owner of a given animal with an associated unique identifier is stored in the livestock database. Each owner is also identified with a unique account ID. Other information associated with each animal unique identifier are gender, state, weight, and other descriptions. More preferably, links to the animal's parent's unique identifiers is possible in a hierarchical and/or relational manner (as in using a relation database management system via foreign keys or similar).

Also provided in the proposed livestock tracking system is a smart phone application 1402 (or other hardware device comprising the same or similar application code as the smart phone application) configured to interact with, or comprises an, identification tag reader (such as the RFID scanners discussed above) as well as being configured to interact with the livestock database system.

FIG. 14 shows a number of events 1420, 1422, 1424, 1426, 1428, 1430 which use the processing platform 1406 to store data for later verification 1432 on the blockchain 1410. Preferably the data stored on the blockchain is in the form of the Data Digest (H_{D}) and/or State Digest (S) as described herein. Said data stored on the blockchain functions as a “signature” on chain and/or a “notarisation”. These terms are used to describe the Data Digest and/or State Digest's function of providing a proof of existence for a verifier to verify the data relating to the events associated with the animal.

A number of the events 1420, 1424, 1426, 1428, 1430, comprise, use, or are associated with an append event. The append event preferably involves the process of storing a transaction on the blockchain such that the transactions is associated with a chain of transactions as described herein. A creation event 1422 preferably involves creation of an event stream and/or creation of a chain of transactions as described herein.

Preferably, a user registering 1420 to the livestock database platform triggers data to be stored on the blockchain 1408. The livestock database generates 1404 creates an account for the user and an associated unique account ID. Notarisation data of the user's account creation is stored on the blockchain. This way, the account ID and any associated metadata with the account is stored in an immutable secure way. Optionally the account also has an event stream (and thus a chain of transactions) associated with it such that any events involving the user can also be tracked.

Upon registration of a new animal 1422, such as a cow, a new event stream is generated such that any further information relating to the animal can be securely associated on the blockchain for later verification.

Example events which might also be recorded on the blockchain include performing dipping 1424, 1430 and performing vaccination 1426 of the animal. Notarisation data representing these events are stored on the blockchain and associated with the same animal's event stream through use of an “append event” as set out in FIG. 14.

If ownership of the animal is transferred from one party to another 1428 (though a sale for example), another append event may be used to record attestation data of the new owner.

Optionally, where the owners have associated event streams, a rendezvous transaction is used to ensure that all of the event streams associated with the seller, the buyer, and the animal, are atomically synchronised on the blockchain and there is never any point in the transaction history, from the point of view of the data stored on the blockchain, where the animal has two owners, no owners, or any other incorrect intermediate state.

Where the animal does not need to be tracked by the livestock database 1404 anymore, a finalise event is provided to the processing platform 1406. With a finalise event, the event stream is finalised, the final transaction stored on the blockchain comprises a null NEXT reference such that and no further events can be appended.

Throughout an animal's lifetime, there exist many points where a proof of an event (such as vaccination) is needed. The chain of transactions provides a proof of existence for all events that have occurred in relation to said animal, including vaccination events. As described herein, storage of this proof of existence on the blockchain therefore provides an immutable secure proof of existence. Where a verifier wishes to determine the validity of a vaccination event, the verifier obtains the State Digest and/or Data Digest associated with the vaccination event, as well as the vaccination event data itself. Preferably, the verifier obtains the vaccination data from the livestock database 1404.

By hashing the vaccination data, a local data digest is obtained. By comparing that the local data digest and the blockchain stored data digest are the same, the verifier verifies that the vaccination data they have received is the same as stored on the blockchain and no data tampering has occurred.

The same or similar process can be conducted using the State Digest, which is based on the Data Digest. Verification using the State Digest requires either a Merkle proof, or, where the State Digest is based on a concatenation of values which are hashed, then some or all of the other data used to generate the hash. Preferably, the Merkle proof or other data is provided by the livestock database 1404 and/or the processing platform 1406.

Of note, the use of the chain of transactions can also be used to show an auditor that no other events than what is being presented changed the stream and/or happened in relation to the animal.

The various methods described above may be implemented by a computer program. The computer program may include computer code arranged to instruct a computer to perform the functions of one or more of the various methods described above. The computer program and/or the code for performing such methods may be provided to an apparatus, such as a computer, on one or more computer readable media or, more generally, a computer program product. The computer readable media may be transitory or non-transitory. The one or more computer readable media could be, for example, an electronic, magnetic, optical, electromagnetic, infrared, or semiconductor system, or a propagation medium for data transmission, for example for downloading the code over the Internet. Alternatively, the one or more computer readable media could take the form of one or more physical computer readable media such as semiconductor or solid-state memory, magnetic tape, a removable computer diskette, a random-access memory (RAM), a read-only memory (ROM), a rigid magnetic disc, and an optical disk, such as a CD-ROM, CD-R/W or DVD.

In an implementation, the modules, components and other features described herein can be implemented as discrete components or integrated in the functionality of hardware components such as ASICS, FPGAs, DSPs or similar devices.

A “hardware component” or “hardware module” is a tangible (e.g., non-transitory) physical component (e.g., a set of one or more processors) capable of performing certain operations and may be configured or arranged in a certain physical manner. A hardware component may include dedicated circuitry or logic that is permanently configured to perform certain operations. A hardware component may be or include a special-purpose processor, such as a field programmable gate array (FPGA) or an ASIC. A hardware component may also include programmable logic or circuitry that is temporarily configured by software to perform certain operations.

Accordingly, the phrase “hardware component” or “hardware module” should be understood to encompass a tangible entity that may be physically constructed, permanently configured (e.g., hardwired), or temporarily configured (e.g., programmed) to operate in a certain manner or to perform certain operations described herein.

In addition, the modules and components can be implemented as firmware or functional circuitry within hardware devices. Further, the modules and components can be implemented in any combination of hardware devices and software components, or only in software (e.g., code stored or otherwise embodied in a machine-readable medium or in a transmission medium).

Unless specifically stated otherwise, as apparent from the following discussion, it is appreciated that throughout the description, discussions utilizing terms such as “determining”, “providing”, “calculating”, “computing,” “identifying”, “combining”, “establishing”, “sending”, “receiving”, “storing”, “estimating”, “checking”, “obtaining” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The term “comprising” as used in this specification and claims means “consisting at least in part of”. When interpreting each statement in this specification and claims that includes the term “comprising”, features other than that or those prefaced by the term may also be present. Related terms such as “comprise” and “comprises” are to be interpreted in the same manner.

It is intended that reference to a range of numbers disclosed herein (for example, 1 to 10) also incorporates reference to all rational numbers within that range (for example, 1, 1.1, 2, 3, 3.9, 4, 5, 6, 6.5, 7, 8, 9 and 10) and also any range of rational numbers within that range (for example, 2 to 8, 1.5 to 5.5 and 3.1 to 4.7) and, therefore, all sub-ranges of all ranges expressly disclosed herein are hereby expressly disclosed. These are only examples of what is specifically intended and all possible combinations of numerical values between the lowest value and the highest value enumerated are to be considered to be expressly stated in this application in a similar manner.

As used herein the term “and/or” means “and” or “or”, or both.

As used herein “(s)” following a noun means the plural and/or singular forms of the noun.

The singular reference of an element does not exclude the plural reference of such elements and vice-versa.

It is to be understood that the above description is intended to be illustrative, and not restrictive. Many other implementations will be apparent to those of skill in the art upon reading and understanding the above description. Although the disclosure has been described with reference to specific example implementations, it will be recognized that the disclosure is not limited to the implementations described but can be practiced with modification and alteration within the scope of the appended claims. Accordingly, the specification and drawings are to be regarded in an illustrative sense rather than a restrictive sense. The scope of the disclosure should, therefore, be determined with reference to the appended claims, along with the full scope of equivalents to which such claims are entitled.

1. A computer implemented method for adding a current transaction associated with a set of transactions in a blockchain system comprising:
generating a first state data, wherein the first state data is based on a first transaction reference to a first transaction and/or a second transaction reference to a second transaction,
generating the current transaction comprising the first state data, and
submitting the current transaction to a blockchain.

2. The method of claim 1, wherein the first transaction reference is based on an output of the first transaction.

3. The method of claim 1, wherein the first transaction reference is based on a second state data of the first transaction.

4. The method of claim 1, wherein the second transaction reference is based on a reference to an input of the second transaction and/or the second transaction reference is based on a reference to a sender account address and a nonce.

5. The method of claim 1, wherein the second transaction reference comprises an unspent transaction outpoint.

6. (canceled)

7. The method of claim 1, wherein the first state data is of a known state size irrelevant of data the first state data is based on.

8-9. (canceled)

10. The method of claim 1, wherein the first transaction reference and/or the second transaction reference are hidden from public view on the blockchain.

11. The method of claim 1, wherein the current transaction is indistinguishable from any other transactions on the blockchain.

12. The method of claim 1, wherein the first state data is at least one of: based on an output of a one-way function taking the first transaction reference and/or the second transaction reference as an input; based on a hash-based data structure based on the first transaction reference and/or the second transaction reference; and a first Merkle tree root of a state Merkle tree and wherein generating the first state data comprises generating the state Merkle tree.

13. The method of claim 1, wherein the first state data is PUSHDATA encoded.

14-20. (canceled)

21. The method of claim 12, wherein the one-way function is a hashing function.

22-26. (canceled)

27. The method of claim 1, wherein the first state data is stored on an output of the current transaction.

28. (canceled)

29. The method of claim 1, wherein the current transaction comprises a second data item.

30-46. (canceled)

47. The method of claim 1, wherein the current transaction belongs to a second set of transactions and a third state data is generated based on a third transaction reference and/or a fourth transaction reference.

48. (canceled)

49. The method of claim 1, wherein the current transaction belongs to a second set of transactions and the first state data is further based on a third transaction reference and/or a fourth transaction reference.

50. (canceled)

51. The method of claim 1, further comprising determining the second transaction reference before the second transaction is generated.

52. The method of claim 1, wherein the first transaction reference comprises data indicative that the current transaction is a first transaction in the set of transactions and/or the second transaction reference comprises data indicative that the current transaction is a last transaction in the set of transactions.

53. (canceled)

54. The method of claim 1, wherein the first transaction reference is a null reference and/or the second transaction reference is a null reference.

55-57. (canceled)

58. A non-transitory computer readable storage medium comprising computer program code instructions, that, when executed by a computer, cause the computer to perform a method for adding a current transaction associated with a set of transactions in a blockchain system, the method comprising:
generating a first state data, wherein the first state data is based on a first transaction reference to a first transaction and/or a second transaction reference to a second transaction,
generating the current transaction comprising the first state data, and
submitting the current transaction to the blockchain system.

59. A computer program product comprising instructions embodied on a non-transitory computer readable medium that, when the computer program product is executed by a computer, cause the computer to carry out a method for adding a current transaction associated with a set of transactions in a blockchain system, the method comprising:
generating a first state data, wherein the first state data is based on a first transaction reference to a first transaction and/or a second transaction reference to a second transaction,
generating the current transaction comprising the first state data, and
submitting the current transaction to the blockchain system.

60-74. (canceled)
